(19) United States
(12) Patent Application Publication
(10) Pub. No.: US 2026/0288876 A1
(43) Pub. Date: Sep. 24, 2026

(54) SYSTEM

(71) Applicant: SoftBank Group Corp., Tokyo (JP)

(72) Inventor: Takuma TACHIBANA, Tokyo (JP)

(73) Assignee: SoftBank Group Corp., Tokyo (JP)

(21) Appl. No.: 19/558,476

(22) Filed: Mar. 6, 2026

(30) Foreign Application Priority Data
Mar. 19, 2025 (JP) 2025-044521

(51) Int. Cl. G06F 16/9038; G06F 16/9032

(52) U.S. Cl. CPC G06F 16/9038; G06F 16/90332

(57) ABSTRACT

A system includes a processor that is configured to provide an interface for receiving input information from a user, analyze a communication application identifier or an information search tool identifier to complement necessary information, and generate and input a prompt for instructing a generative artificial intelligence model to generate a response.

### CROSS-REFERENCE TO RELATED APPLICATION

This application is based on and claims priority under 35 USC 119 from Japanese Patent Application No. 2025-044521 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information processing systems that assist users in performing procedures or generating documents generally rely on manually entered user information and static templates. In such systems, a user is often required to repeatedly input similar personal information and context information for each new task, such as address change procedures, service applications, or inquiries. This not only increases user burden but also introduces a higher risk of inconsistent or incomplete input, which can lead to errors or delays in subsequent processing.

Furthermore, existing systems typically fail to make effective use of identifiers associated with communication applications or information search tools, such as messenger IDs or search account IDs, which could otherwise be exploited to complement missing user information or infer relevant context. As a result, opportunities to reduce input operations and to enhance personalization are not sufficiently realized.

In addition, while generative artificial intelligence models have recently been employed to create responses or draft documents, conventional systems often provide only simple prompts that do not take into account complemented user information or contextual data obtained from various identifiers. Therefore, response quality and task suitability may be limited.

Moreover, existing user authentication schemes often rely solely on basic credentials, and do not sufficiently leverage public authentication systems and biometric information to ensure reliable identity verification when performing important procedures, such as address changes. This can cause security concerns and hinder the adoption of automatic document generation and submission systems for official processes.

Accordingly, there is a need for a system that can: (i) receive user input information efficiently, (ii) analyze communication application identifiers or information search tool identifiers to complement necessary information, (iii) generate prompts tailored to a generative artificial intelligence model based on the complemented information, and (iv) in certain embodiments, cooperate with public authentication systems using biometric information to improve the reliability of authentication for sensitive procedures such as address changes.

### SUMMARY

To solve at least part of the foregoing problems, an aspect of the present invention provides a system comprising a processor, wherein the processor is configured to provide an interface for receiving input information from a user, analyze a communication application identifier or an information search tool identifier to complement necessary information, and generate and input a prompt for instructing a generative artificial intelligence model to generate a response.

In one embodiment, the processor provides, via a terminal, a graphical or conversational interface through which the user inputs basic information relating to a desired task. By way of example, the processor provides an interface through which the user inputs an address change request including at least a new address and a date of relocation. The processor receives this input information, associates it with the user's communication application identifier or information search tool identifier, and stores it in a user profile or session context.

In another embodiment, the processor analyzes the communication application identifier, such as a messenger ID, to obtain profile information including, for example, a user name, contact information, or language preference. The processor further analyzes an information search tool identifier, where available, to obtain search history, preference information, or other context data. The processor complements necessary information in the user profile by populating missing fields (such as name, email address, or frequently used addresses) based on the data obtained through the identifiers. The processor thereby reduces the amount of information that must be manually provided by the user and improves consistency of the stored user data.

In a further embodiment, when the processor determines, based on the input information from the user, that the input information relates to an address change, the processor automatically generates a document required for an address change procedure. For example, the processor creates an address change notification document or an application form for updating registration information, using both the user's input and the complemented information. The processor may cause the generative artificial intelligence model to draft or refine the content of such documents by generating and inputting a prompt that includes the complemented user information and the task specification.

In addition, in certain embodiments, the processor is configured to cooperate with a public authentication system using biometric information of the user to improve reliability of authentication. Specifically, the processor initiates an authentication flow with a public authentication system and, in coordination with a terminal that captures biometric information (such as fingerprint, facial image, or other biometric data), obtains an authentication result. The processor then associates the authenticated identity with the user profile and restricts the automatic generation or submission of sensitive documents, such as address change documents, to cases in which authentication has been successfully completed.

Through these configurations, the system according to the present invention enables: (i) efficient collection of user input information via an interface, (ii) automatic completion of necessary information using communication application or search tool identifiers, (iii) generation of context-rich prompts for instructing a generative artificial intelligence model to generate appropriate responses or documents, and (iv) enhanced reliability of authentication when sensitive procedures such as address changes are involved. Consequently, the invention reduces user burden, improves accuracy and consistency of generated content, and enhances security and trustworthiness of automated procedures.

The term “system” refers to an information processing apparatus, or a combination of one or more apparatuses, including at least one processor and, optionally, one or more memories, communication interfaces, and input/output devices, configured to execute the functionalities described in the claims.

The term “processor” refers to a hardware circuit, such as a central processing unit (CPU), microprocessor, microcontroller, or dedicated processing circuitry, that executes instructions to perform logical, arithmetic, control, and input/output operations to implement the claimed functions.

The term “interface” refers to a hardware, software, or combination layer that enables exchange of information between the system and a user or between the system and another system, including but not limited to graphical user interfaces, command-line interfaces, application programming interfaces, and messaging interfaces.

The term “input information” refers to any data, command, parameter, or content provided by a user to the system through an interface, including but not limited to textual information, structured form data, selections, and other user-specified information.

The term “user” refers to a human operator or entity that interacts with the system, provides input information, receives outputs or responses from the system, and optionally requests execution of tasks such as document generation or address change procedures.

The term “communication application identifier” refers to an identifier associated with a communication application account or session of the user, such as a messenger ID, chat application ID, or other communication service account ID, which can be used by the system to retrieve or associate user-related data.

The term “information search tool identifier” refers to an identifier associated with a search engine account, browser profile, or other information retrieval tool used by the user, which can be used by the system to obtain search history, preference data, or related context information.

The term “analyze” refers to the processing of one or more identifiers or data items by the processor to extract, interpret, correlate, or derive information, including parsing, matching, querying external services, or applying rules or models to obtain complementary or contextual data.

The term “complement necessary information” refers to the operation in which the processor fills in, infers, or supplements missing or incomplete information in user data or a task context using information obtained from communication application identifiers, information search tool identifiers, or other sources.

The term “prompt” refers to a set of instructions, text, parameters, or structured data generated by the processor and provided as input to a generative artificial intelligence model, which defines or constrains the task to be performed by the model and specifies context, user information, or desired output characteristics.

The term “generative artificial intelligence model” refers to a machine learning model, such as a large language model, text generation model, or other generative model, configured to produce outputs including text, documents, or other content in response to an input prompt.

The term “generate a response” refers to the operation in which the generative artificial intelligence model produces output content, such as explanatory text, instructions, document drafts, or other information, based on a prompt provided by the processor.

The term “address change” refers to a change in the registered residential or contact address of a user and includes associated procedures for updating official records, service contracts, or registrations with public or private entities.

The term “document required for an address change procedure” refers to any form, application, notification, or other record, in electronic or physical format, that is required by a government agency, public institution, or private organization to process an address change for the user.

The term “automatically generate” refers to the operation in which the processor, without requiring manual drafting of the entire content by the user, creates at least a part of the content or structure of a document or response based on user input information and complemented information.

The term “biometric information” refers to information derived from measurable biological or behavioral characteristics of a user, including but not limited to fingerprints, facial images, iris patterns, voice characteristics, or other biometric features suitable for identity verification.

The term “public authentication system” refers to an authentication infrastructure operated or authorized by a governmental body or public institution, such as a national ID platform or similar official system, which is used to verify the identity of a user and, optionally, associated attributes.

The term “cooperate with a public authentication system” refers to the operation in which the processor exchanges data or authentication requests with a public authentication system, initiates or controls an authentication flow, and receives or processes authentication results for the purpose of verifying the user.

The term “reliability of authentication” refers to the degree of confidence that a user has been correctly identified by the authentication process, including resistance to impersonation or fraud, and the assurance that the authenticated identity corresponds to the actual user performing the procedure.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

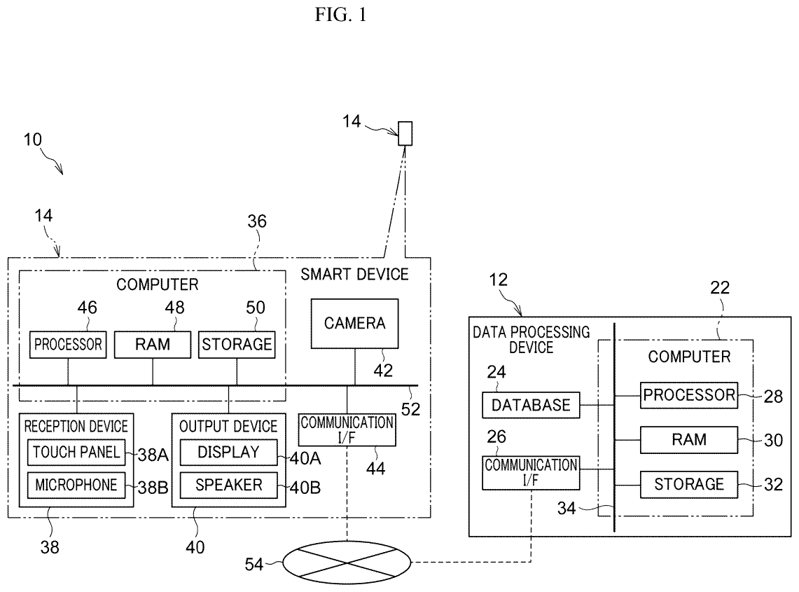

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

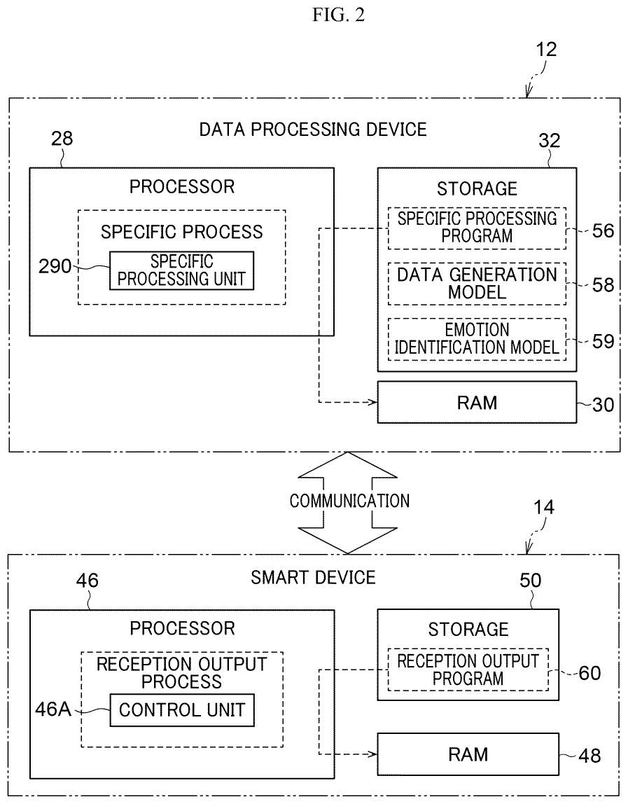

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In network-based information processing environments, users increasingly rely on natural language interfaces executed on information processing terminals to obtain information, generate documents, and complete procedures. Conventional systems that forward raw user input directly to a generative AI model often suffer from several technical shortcomings.

First, conventional systems typically perform only superficial preprocessing of user input, without robust natural language analysis or structured context construction. As a result, the generative AI model receives under-specified or noisy input, which leads to unstable output quality, unnecessary back-and-forth interactions, and increased computational load due to repeated, corrective calls to the model. This degrades system-level performance, including response latency, network usage, and utilization efficiency of remote inference resources.

Second, conventional systems are not designed to systematically combine user input, application-specific context, user attributes, and past dialogue history into an optimized prompt sentence suitable for a generative AI model. In many cases, conversational context is either omitted or redundantly included, causing either loss of relevant information or inefficient use of token budgets. This lack of structured prompt generation adversely affects the accuracy and consistency of model outputs, and reduces the effective throughput of the server infrastructure.

Third, in tasks requiring structured output, such as generating application documents for address changes or other administrative procedures, conventional systems do not reliably map the generative AI model's free-form output into structured templates. This causes additional manual correction by the user, undermines the intended automation, and increases the risk of incomplete or inconsistent electronic documents, which in turn negatively impacts downstream information systems that expect structured data.

Fourth, in operations that involve sensitive or legally significant content, such as application submissions or transaction confirmations, existing systems often separate biometric authentication and content confirmation from the generative AI processing pipeline, or handle them only at the client side. This fragmented handling leads to weak coupling between generated content and verified identity, making it difficult to guarantee that the finalized content has been confirmed by an authenticated user, and preventing the server from reliably enforcing content-level verification policies.

Accordingly, there is a need for an improved computer-implemented system and server architecture that (i) converts free-form user input into structured data using natural language processing, (ii) dynamically constructs and optimizes prompt sentences for a generative AI model using complementary information such as user attributes, region information, and past dialogue history, (iii) performs systematic post-processing and template filling on the generated response to produce structured response data suitable for screen display or electronic documents, and (iv) tightly integrates biometric authentication and server-side content confirmation before finalizing application or transaction content. Such improvements are expected to enhance the technical performance of the overall information processing system, including response accuracy, processing efficiency, and reliability of authenticated transactions.

The specific processing by the specific processing unit 290 of the data processing device 12 in Example 1 is realized by the following means.

The present invention provides a server comprising a processor configured to receive, via a communication network, user input information and application identification information transmitted from an information processing terminal, perform natural language processing on the user input information to extract a user request and related items, acquire complementary information including time information, region information, user attribute information, and past dialogue history information based on the extraction result and the application identification information, and organize the user input information and the complementary information as structured data; generate, on the basis of the structured data, a prompt sentence including dialogue history information and response style conditions, adjust the prompt sentence so that the prompt sentence falls within a predetermined token range, and input the prompt sentence to a generative AI model implemented as a generative information processing model; obtain response information generated by the generative AI model, perform server-side post-processing on the response information by unifying an expression format, adjusting a language type, and removing unnecessary information, and, when necessary, integrate the post-processed response information with additional information acquired from an external information providing apparatus to generate response data suitable for screen display or electronic document generation; and transmit the response data to the information processing terminal.

The present invention further provides that the processor is configured, when it is determined from the structured data that the user request relates to a change of residential information, to generate and input to the generative AI model a specialized prompt sentence including a body text candidate and an input item candidate for a document used in a residential information change procedure, and to automatically generate or complement description regions in an application-form template by mapping the response information from the generative AI model into predefined template fields, thereby producing structured electronic document data. The present invention further provides that the processor is configured, before finalizing application content or transaction content included in the response data, to receive biometric authentication information and authentication information from the information processing terminal, verify user identity in cooperation with an authentication apparatus, and generate and retransmit content confirmation display information based on the verification result and the response data, thereby coupling authenticated identity with the generated content at the server.

This enables the server to technically improve the overall information processing pipeline by transforming unstructured user input into optimized prompt sentences for a generative AI model, efficiently utilizing model resources within token constraints, generating structured and context-appropriate response data including electronic documents, and enforcing server-side, identity-bound content confirmation, thereby enhancing response accuracy, processing efficiency, and reliability of authenticated computer-implemented transactions.

The term “system” refers to an arrangement of one or more hardware devices and software components that cooperate to execute information processing operations as described in the claims.

The term “processor” refers to a hardware computation unit, such as a central processing unit or a processing core, configured to execute instructions that implement the functions recited in the claims.

The term “information processing terminal” refers to an electronic apparatus, such as a portable terminal, a stationary terminal, or a general-purpose computing device, operated by a user and configured to transmit user input information and receive response data via a communication network.

The term “communication network” refers to a wired or wireless data communication infrastructure, including one or more networks such as a local area network or a wide area network, that enables data exchange between the information processing terminal and the server.

The term “user input information” refers to information expressing a user's request or instruction, including at least natural language text entered by the user through an input interface of the information processing terminal.

The term “application identification information” refers to information indicating a type, category, or identifier of a software application, service, or tool used by the user to provide the user input information.

The term “natural language processing” refers to a series of computational operations on text data, including at least tokenization, linguistic analysis, and extraction of semantic elements, for the purpose of deriving a user request and related items.

The term “user request” refers to a semantic representation of a task, inquiry, or operation desired by the user, extracted from the user input information using natural language processing.

The term “related items” refers to additional semantic elements associated with the user request, such as entities, parameters, constraints, or conditions, identified through analysis of the user input information.

The term “complementary information” refers to information that supplements the user input information and the user request, including at least time information, region information, user attribute information, and past dialogue history information.

The term “time information” refers to data indicating a temporal context, such as a date, time, or time period, associated with the user request.

The term “region information” refers to data indicating a geographical or jurisdictional area associated with the user request, such as a place name, administrative region, or service area.

The term “user attribute information” refers to data describing characteristics of the user, such as profile data, preferences, or previously registered information, stored in association with the user.

The term “past dialogue history information” refers to data representing previous exchanges between the user and the system, including prior user inputs and system responses, stored as context for subsequent processing.

The term “structured data” refers to information organized according to a predefined schema or data model, in which elements such as the user request, related items, and complementary information are expressed as explicitly labeled fields or records.

The term “prompt sentence” refers to text data generated by the processor as input to a generative AI model, the text data including instructions, context, and constraints formatted in natural language or a model-interpretable representation.

The term “response style conditions” refers to parameters or instructions specifying how the generative AI model should formulate an output, including at least conditions on language, tone, length, or format.

The term “token range” refers to a constraint on the size of a prompt sentence or a generated response, expressed in units of model tokens, characters, or words, used to limit computational cost or comply with model specifications.

The term “generative AI model” refers to a trained computational model capable of generating output data, such as natural language text, in response to an input prompt sentence, based on probabilistic or learned representations.

The term “generative information processing model” refers to a generative AI model that processes input information and generates response information, and may include one or more neural network models or similar generative architectures.

The term “response information” refers to output data generated by the generative AI model in response to a prompt sentence, including at least natural language text representing an answer, explanation, or content draft.

The term “server-side post-processing” refers to processing operations performed by the processor after receiving response information from the generative AI model, including at least normalization of expression format, adjustment of language type, and removal of unnecessary information.

The term “expression format” refers to structural and stylistic characteristics of text, such as use of specific character sets, punctuation rules, layout conventions, or text segmentation.

The term “language type” refers to a classification of a natural language used in text, such as a particular human language or dialect selected for the response.

The term “unnecessary information” refers to portions of response information that are not required for fulfilling the user request or system specification, such as redundant explanations, disclaimers, or extraneous content.

The term “external information providing apparatus” refers to an apparatus or system, such as an external server or service, that supplies additional information used by the processor to supplement the response information.

The term “response data” refers to data generated by the processor after post-processing and integration, suitable for output to the information processing terminal, and may include text, structured records, or document representations.

The term “screen display data” refers to data formatted for visual presentation on a display device of the information processing terminal, including layout information and content elements.

The term “electronic document data” refers to digital data representing a document in a machine-readable format, such as a structured template, a word-processing file, or a document for electronic transmission or storage.

The term “residential information” refers to data relating to a user's place of residence, domicile, or address, used in administrative or procedural contexts.

The term “application-form template” refers to a structured document model defining one or more description regions or fields for entry of information required in an application procedure.

The term “description region” refers to a defined portion of an application-form template designated for inclusion of specific textual content or data items.

The term “body text candidate” refers to candidate textual content suitable for inclusion as the main body of a document, generated or specified as part of a prompt sentence.

The term “input item candidate” refers to candidate field definitions or entries indicating what information should be input into specific fields of a document or template.

The term “structured electronic document data” refers to electronic document data whose content is arranged according to a template or schema, enabling machine processing, validation, or automated submission.

The term “biometric authentication information” refers to data derived from a user's biological characteristics, such as a fingerprint, facial feature, or voice pattern, used to perform identity verification.

The term “authentication information” refers to data used to verify identity or authorization, including at least credentials, tokens, or authentication results transmitted from the information processing terminal.

The term “authentication apparatus” refers to a device or system that performs authentication processing, such as verifying biometric authentication information or other authentication information.

The term “verification result” refers to outcome data generated by the authentication apparatus or processor indicating whether a user's identity has been successfully verified, and possibly including additional attributes such as authentication level.

The term “application content” refers to information representing the substantive content of an application prepared or supported by the system, including fields and statements contained in an application-form or electronic submission.

The term “transaction content” refers to information representing terms, details, or parameters of a transaction or operation that is subject to confirmation or finalization by the user.

The term “content confirmation display information” refers to data generated for presentation on the information processing terminal, enabling a user to review, verify, or approve application content or transaction content associated with an authenticated identity.

In one embodiment, a server executes a computer program on one or more processors to implement the claimed system. The server includes at least one central processing unit, a main memory, a non-volatile storage device such as a solid-state drive, and a network interface connected to a communication network. The server executes an operating system such as a general-purpose server operating system, and executes middleware such as a web server and an application execution environment. The server uses an application framework, for example a web application framework implemented in a programming language, to host an application that performs natural language processing, prompt sentence generation, invocation of a generative AI model, and post-processing of response data.

The terminal operates as an information processing terminal and includes a processor, a memory, a display, and an input interface such as a touchscreen or keyboard. The terminal executes a client application such as a communication application or a web browser, and the client application transmits user input information to the server and receives response data from the server via the communication network. The user interacts with the terminal by entering natural language text, audio that is converted to text, or other input, and by viewing responses, reviewing generated electronic documents, and confirming content.

The server executes a natural language processing module to convert unstructured user input information into structured data. The server loads natural language processing libraries, such as a tokenization library and a syntactic and semantic analysis library, into memory, and uses them to process the user input information. The server performs tokenization by segmenting the input character sequence into tokens using a deterministic or statistical tokenizer. The server performs part-of-speech tagging by assigning part-of-speech labels to each token using a trained sequence labeling model. The server performs named entity recognition by applying a neural sequence labeling model, such as a bidirectional recurrent neural network with a conditional random field output layer, to identify entity spans corresponding to dates, times, locations, person names, and other semantic categories. The server further applies intent classification using a classifier implemented as a feed-forward neural network or a transformer-based encoder that maps the token sequence into an intent label representing the user request.

The server stores the analysis results as structured data in a data structure in memory, such as a key-value mapping or an object with fields. For example, the server stores an intent field indicating a category such as “weather inquiry” or “residential address change,” stores a date field normalized to an absolute date using a calendar conversion function, and stores a region field normalized to a standardized code corresponding to a geographic region. The server also stores user attribute information, such as a preferred language code and a default region code, obtained from a user profile record in a database. The server stores past dialogue history information, including previous user inputs and previous responses, in a session store associated with a session identifier, and the server retrieves this history when generating context-aware prompt sentences.

The server generates a prompt sentence for a generative AI model based on the structured data and complementary information. The server maintains one or more prompt templates in a storage device, each template including placeholders for intent descriptions, time information, region information, and dialogue history. The server selects a template according to the intent field and fills each placeholder with corresponding values. The server executes string operations to construct a natural language instruction that is optimized for use with the generative AI model. For a simple weather inquiry, the server may construct a prompt sentence such as:
“The user wants to know the weather for 2026-01-30 in Tokyo. Use the latest available public information. Answer in Japanese in one short sentence.”

For a follow-up question that relies on dialogue history, the server may construct a prompt sentence such as:
“The conversation so far: User: ‘Tell me tomorrow's weather in Tokyo.’ Assistant: ‘Tomorrow's weather in Tokyo will be sunny.’ Now the user asks: ‘What about the day after tomorrow?’ Please answer in Japanese in one sentence, describing the expected weather in Tokyo for the day after tomorrow.”

For document creation related to residential information change, the server may construct a prompt sentence such as:
“The user needs a formal application letter in Japanese to request a change of residential address at a local government office. Use polite and standard business Japanese. Include placeholders [user_name], [address], and [date]. Output only the letter body without any explanation or additional text.”

The server further enforces a token range constraint for each prompt sentence. The server estimates the number of tokens by applying a tokenization function consistent with the generative AI model's tokenization scheme. The server truncates or summarizes parts of the dialogue history or reduces non-essential explanatory text when the estimated token count exceeds a threshold. The server may employ a heuristic algorithm that preferentially retains more recent dialogue turns and drops older turns, or compresses them into shorter summaries using an auxiliary summarization model, so that essential context is preserved while overall token usage is reduced. By controlling the prompt length in this way, the server reduces inference latency and network payload size for requests to the generative AI model and increases the number of parallel requests that can be processed within given computational resources.

The server communicates with the generative AI model over the communication network. In one embodiment, the generative AI model executes on a remote inference environment that includes one or more graphics processing units. The generative AI model is implemented as a transformer-based neural network including an embedding layer, multiple encoder-decoder or decoder-only layers with multi-head self-attention mechanisms, feed-forward sublayers, and layer normalization. The server transmits the prompt sentence as a sequence of tokens or encoded characters to a model inference endpoint. The model internally maps each token to a high-dimensional vector embedding, computes attention weight matrices for pairs of tokens, and performs matrix multiplications and non-linear transformations to generate a probability distribution over the next token at each step. The model then samples or selects tokens according to generation parameters such as a temperature parameter and a maximum token limit, thereby producing response information as a sequence of tokens that the server decodes into text.

The server benefits from improvements in computer technology by controlling how input data is prepared and how model resources are used. The server's structured prompt construction reduces redundancy and ambiguity in inputs to the generative AI model, which in turn reduces the number of calls and the total number of processed tokens required to satisfy user requests. The server thus decreases average processing time and improves throughput for multiple concurrent sessions. The explicit token range control also reduces communication payload sizes for each request and response, leading to reduced network congestion and improved responsiveness for users.

The server performs training of the generative AI model and related auxiliary models in advance. The server or another training system constructs a training dataset including pairs of prompt sentences and desired responses, and may further include labels for intent classification and named entity recognition. During training, the system computes a loss function, such as a cross-entropy loss between predicted token distributions and ground-truth tokens, and updates the model's weights using an optimization algorithm, such as stochastic gradient descent with momentum or an adaptive gradient method. The system performs backpropagation through the transformer layers, adjusts attention weights and feed-forward parameters, and may use regularization techniques such as dropout and weight decay. The server may also use data augmentation techniques, such as paraphrasing sentences or varying entity values, to improve model robustness. These training operations produce a generative AI model and auxiliary models that are optimized for generating consistent, context-aware responses based on structured prompt sentences.

The server distinguishes its processing from a mere automation of human tasks by performing non-conventional, machine-oriented operations on data. The server does not merely pass natural language to a generative AI model; instead, the server decomposes input into structured representations, uses a combination of rule-based logic and learned models to select and assemble prompt segments, and applies explicit constraints on length, language, and style that are difficult for a human operator to enforce consistently in real time. The server, for example, uses a non-standard, machine-oriented rule that encodes dialogue history as a compact meta-description rather than copying the entire history verbatim, and this rule reduces token usage while preserving essential semantics. The server also applies an ordering rule that places system-level instructions at the beginning of the prompt sentence and user text at the end, which improves the generative AI model's adherence to desired output formats by exploiting known properties of attention distribution in transformer architectures.

The server performs post-processing on the response information returned by the generative AI model. The server first normalizes the expression format by converting character encodings, mapping punctuation symbols to a standardized set, and enforcing uniform paragraph breaks according to display requirements. The server then enforces a language type requirement by applying a language detection model; if the response is not in the requested language, the server may translate it using a machine translation module or may request re-generation with a modified prompt. The server also removes unnecessary information such as prefaces, disclaimers, or model-generated meta-comments by applying pattern-matching rules or by using a classifier model trained to identify such segments. In the case of document creation, the server parses the response into sections corresponding to document fields and populates fields in an application-form template structure with the extracted sections.

The server manages templates for electronic documents in a data storage system. Each application-form template specifies description regions and associated field identifiers. When the user request relates to residential information change, the server generates a specialized prompt sentence that instructs the generative AI model to output text segments corresponding to specific fields. For example, the server may use a prompt sentence such as:
“The user wants to apply to change their registered residential address. Draft a formal Japanese application letter including separate sections for: (1) addressee (office name), (2) applicant information, (3) request statement, and (4) date. Use polite business Japanese. Output each section separated by a blank line.”

The server receives the response information, parses the text by section, and maps each section into corresponding fields in the template. The server then generates structured electronic document data, in which each field is stored with a label and value, and may additionally convert this structure into a human-readable file format such as a document file or a portable document file using a document conversion library.

The server integrates biometric authentication and content confirmation functions into the same processing pipeline. When the response data includes application content or transaction content to be finalized, the server requests biometric authentication information and authentication information from the terminal. The terminal acquires biometric authentication information from a biometric sensor, such as a fingerprint reader or a camera, and transmits authentication information such as a credential or an authentication token. The server forwards this information to an authentication apparatus or executes a verification algorithm locally. The server then associates the verification result with the response data in a data structure, and generates content confirmation display information that includes both the textual content and an indication of the verified identity. By coupling identity verification and content generation at the server, the system assures that the finalized electronic document or transaction record is directly linked to a successfully authenticated user. This linkage enables the server to enforce policies that prevent unverified users from submitting or modifying critical content, thereby improving the reliability of authenticated computer-implemented transactions.

The terminal presents the response data and confirmation information to the user in a structured and interactive manner. The terminal's client application parses response data received from the server, renders natural language text in a chat-style interface or a form view, and presents document previews with fields clearly delineated. The terminal may provide interactive elements such as buttons for approving, rejecting, or editing generated content. When the user modifies content, the terminal transmits only the changed fields back to the server, thereby reducing communication payload sizes and enabling the server to update only necessary parts of the structured document data.

The system achieves technical improvements by combining these components and processes. The natural language processing and structured representation reduce noise and ambiguity in input data. The template-based and context-aware prompt sentence construction increases the likelihood that the generative AI model outputs relevant and well-structured content in a single generation step, thereby reducing repeated calls and computational overhead. The token range control and history summarization reduce average token counts, improving inference speed and reducing network traffic. The server-side post-processing and template mapping transform free-form text into structured electronic documents that can be programmatically validated and stored, improving data integrity and machine readability. The integrated authentication and content confirmation ensures that the system produces records that are reliably associated with verified users, improving the trustworthiness of computer-implemented procedures.

In alternative embodiments, the server may use different types of generative AI models, such as encoder-decoder sequence-to-sequence models or hybrid models that combine rule-based generation with neural text generation. The server may also vary the structure of prompt sentences according to language or domain, may use different loss functions and optimization algorithms when training models, and may adopt different data structures for structured data and templates, such as hierarchical trees or graph-based representations. The server may execute the generative AI model locally on the same hardware in smaller deployments, or may distribute processing across multiple servers for load balancing and redundancy.

In another embodiment, the terminal may execute a lightweight natural language pre-processing module, such as language detection or basic tokenization, prior to sending data to the server, which reduces processing load on the server and allows the server to allocate more resources to sophisticated prompt construction and model inference management. In yet another embodiment, the server may log token counts, response latencies, and error rates for different prompt patterns, and may adapt prompt templates over time according to measured performance using a reinforcement learning or bandit-style algorithm, thereby further improving computational efficiency and output quality.

By designing the server, terminal, and user interactions in these ways, the system provides concrete improvements to computer technology. The system changes how input is represented and processed inside the computer, how neural network resources are invoked and controlled, and how electronic documents and authenticated transactions are generated and verified, rather than merely automating a human office procedure.

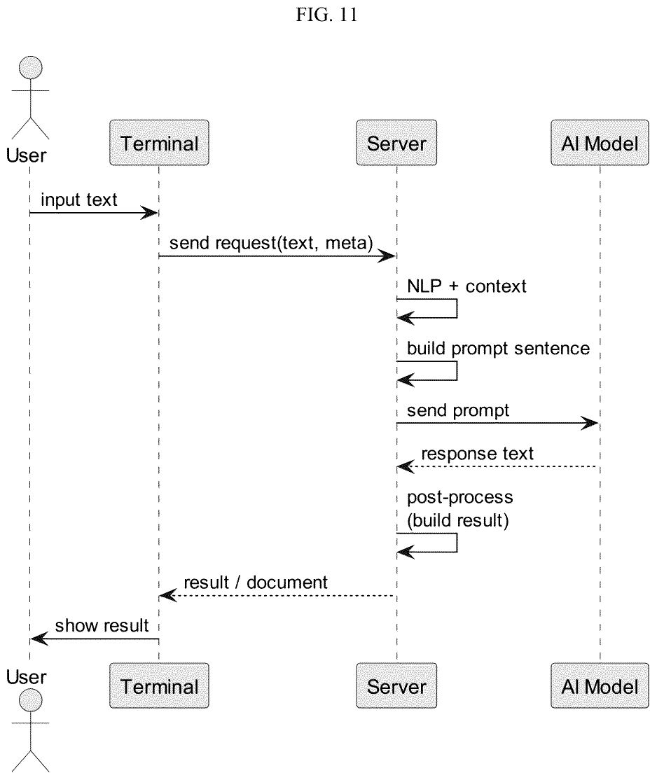

The following describes the processing flow using FIG. 11.

### Step 1:

The user operates the terminal and launches a client application such as a communication application or a web browser. The user inputs natural language text, for example “Tell me tomorrow's weather in Tokyo” or “Create a draft of an application letter to change my residential address,” through a keyboard, touchscreen, or voice-to-text interface.

Input: raw user text and basic context such as timestamp and session identifier.

Output: user input information held in the terminal's memory as a text string and metadata.

The terminal stores the text in an internal data structure and prepares it for transmission.

### Step 2:

The terminal constructs a request message including the user input information, application identification information, user identifier, and session identifier. The terminal encodes the data, for example using UTF-8, and packages the data into a structured format such as a JSON object. The terminal then transmits the request to the server via a communication network using a secure protocol such as HTTPS.

Input: user input text, application identification information, user identifier, session identifier.

Output: a network request message containing the encoded user input information and metadata, sent toward the server.

The terminal thereby converts user actions into machine-readable data suitable for network transfer.

### Step 3:

The server receives the HTTPS request via a network interface and a web server module. The server decodes the HTTP headers and the message body, parses the JSON object, and validates required fields such as the presence of user input information and application identification information. The server assigns a unique request identifier and writes a log entry including the request identifier, timestamp, and originating terminal identifier.

Input: encoded request message from the terminal.

Output: parsed user input information and associated metadata stored in the server's working memory, and a log record stored in persistent storage.

The server thus transforms a raw network message into internal data structures for further processing.

### Step 4:

The server executes a natural language processing pipeline on the user input information. The server applies a tokenizer to split the text into tokens, applies a part-of-speech tagger to assign grammatical categories, and runs a named entity recognition model to identify entities such as dates, locations, and document types. The server then applies an intent classifier to determine whether the user request is an information query, a residential information change request, or another category.

Input: user input text.

Output: an analysis result comprising an intent label (for example “get_weather” or “change_residential_address”), extracted entities (for example date and region), and linguistic annotations, stored in a structured representation.

The server converts unstructured text into labeled semantic components through a sequence of machine learning computations.

### Step 5:

The server acquires complementary information to complete missing or implicit elements in the analysis result. The server reads user attribute information such as a default region and preferred language from a user profile database by querying with the user identifier. The server combines the extracted entities with user attribute information and normalizes date expressions (for example “tomorrow”) into absolute dates using a calendar function, and normalizes region names into standardized region codes. The server also retrieves past dialogue history information from a session store and selects recent exchanges relevant to the current intent.

Input: analysis result from the natural language processing pipeline, user identifier, session identifier.

Output: complementary information including normalized time information, region information, user attribute information, and selected past dialogue history, merged into an enriched context object.

The server thus supplements and refines the extracted semantics to form a complete contextual state.

### Step 6:

The server organizes the user input information, analysis result, and complementary information into structured data. The server constructs an internal data object, for example a record with fields for intent, time, region, user attributes, and dialogue history. The server populates each field with values from the previous steps and ensures type consistency, such as storing dates in a standardized date format and region information as codes.

Input: enriched context object and original user input text.

Output: structured data representing the user request and context in a machine-processable schema.

The server thus maps heterogeneous data into a unified structure that can drive prompt generation and downstream processing.

### Step 7:

The server selects a prompt template based on the intent in the structured data. For an information query, the server chooses an information-retrieval-oriented template; for a residential information change request, the server chooses a document-generation-oriented template. The server fills placeholders in the template with values from the structured data, such as inserting the normalized date, region, and dialogue history text. The server then assembles these elements into a prompt sentence written in natural language.

Input: structured data including intent, time, region, user attributes, and dialogue history.

Output: an initial prompt sentence containing instructions, contextual information, and output constraints tailored to the generative AI model.

The server performs string concatenation and template substitution operations to construct a model-ready instruction from the structured representation.

### Step 8:

The server adjusts the prompt sentence to satisfy a predetermined token range constraint. The server estimates the number of tokens by applying a tokenization function consistent with the generative AI model's tokenizer. If the estimated token count exceeds a threshold, the server shortens the dialogue history portion using a summarization algorithm or drops older exchanges while keeping the most recent ones. The server may also remove non-essential modifiers or explanatory phrases that do not affect the core instruction.

Input: initial prompt sentence and token range parameters.

Output: an optimized prompt sentence whose estimated token length is within the allowed token range.

The server thus reduces token usage and model computation cost while preserving essential semantics.

### Step 9:

The server prepares a request for the generative AI model. The server packs the optimized prompt sentence, model selection parameters (such as model type and version), and generation parameters (such as maximum output tokens and temperature) into a structured payload. The server transmits this payload over the communication network to a model inference endpoint. The server then waits for the response while tracking the request using the unique request identifier.

Input: optimized prompt sentence and configuration parameters for the generative AI model.

Output: a model invocation request sent to the generative AI model service.

The server thereby initiates a controlled generation operation with clearly defined inputs and limits.

### Step 10:

The generative AI model processes the prompt sentence and returns response information to the server. The model internally performs tokenization, embedding, attention, and probabilistic decoding operations to generate the response text. The server receives the model's output payload and decodes the sequence of tokens into a text string representing the generated response.

Input: model invocation request including the prompt sentence.

Output: raw response information from the generative AI model, represented as generated text.

The server converts the model's token sequence into text and stores it in working memory for further processing.

### Step 11:

The server performs post-processing on the response information. The server normalizes character encoding, converts variant symbols to standard forms, and harmonizes punctuation and line breaks to match display and document formatting rules. The server runs a language detection algorithm to confirm that the generated text matches the user's preferred language; if not, the server invokes a translation module or, alternatively, regenerates a response with a revised prompt. The server applies rules or a classifier to remove unnecessary prefatory or trailing text, leaving only content that directly answers the user request or fills document fields.

Input: raw generated text from the generative AI model and user attribute information including preferred language.

Output: cleaned response text with normalized formatting, correct language, and removed extraneous content.

The server transforms the model's generic output into a form that is consistent and suitable for downstream use.

### Step 12:

The server determines whether the response corresponds to a structured document generation task. When the structured data indicates a residential information change, the server parses the cleaned response text into logical sections corresponding to predefined fields, such as addressee, applicant information, request statement, and date. The server uses delimiter patterns or section headers to segment the text and maps each segment to fields defined in an application-form template.

Input: cleaned response text and application-form template definition.

Output: structured electronic document data comprising labeled fields populated with generated content.

The server converts free-form text into a structured document layout that can be stored, inspected, and transmitted as an electronic document.

### Step 13:

The server checks whether biometric authentication and content confirmation are required before finalizing the response data. For content categorized as application content or transaction content, the server generates a request to the terminal for biometric authentication information and authentication information. The server embeds a reference to the current structured electronic document data in this request so that the terminal can associate the authentication with the specific content.

Input: structured electronic document data or critical response content, and policy rules indicating authentication requirements.

Output: an authentication request message transmitted to the terminal, including an identifier of the content awaiting confirmation.

The server initiates a secure identity verification and content approval phase when necessary.

### Step 14:

The terminal receives the authentication request and prompts the user to provide biometric authentication information and authentication information. The terminal interacts with biometric sensors to capture biometric data, such as a fingerprint or facial image, and collects credentials, such as a password or token, through a secure input screen. The terminal packages this data into an authentication response message and transmits it to the server over the communication network.

Input: authentication request from the server and user interactions with biometric sensors and input interfaces.

Output: authentication response message containing biometric authentication information and authentication information, sent to the server.

The terminal thus converts physical biometric signals and user credentials into digital data for server-side verification.

### Step 15:

The server verifies the received biometric authentication information and authentication information by cooperating with an authentication apparatus or executing verification algorithms locally. The server receives an authentication result, such as success or failure and an authentication level, and associates this result with the structured electronic document data or response content. If authentication is successful, the server generates content confirmation display information that includes the full text of the generated content and an indication of the verified identity. The server then transmits this display information to the terminal.

Input: authentication response message, authentication apparatus output, and structured electronic document data or response content.

Output: content confirmation display information bound to a verified user identity, sent to the terminal.

The server thus links identity verification results to specific generated content before finalizing the transaction.

### Step 16:

The terminal displays the content confirmation display information to the user. The terminal renders the generated text in a readable layout, optionally highlighting fields and listing any changes made by the generative AI model. The terminal provides controls for the user to approve, reject, or edit individual fields. The user reviews the content, makes corrections if necessary, and uses the terminal interface to submit a final decision. The terminal transmits the user's decision and any modified data fields back to the server.

Input: content confirmation display information and user interactions with the displayed content.

Output: a finalization message containing user approval status and any modified content fields, transmitted to the server.

The terminal thereby enables human review and explicit consent while capturing fine-grained changes in structured form.

### Step 17:

The server receives the finalization message and updates the structured electronic document data or response content accordingly. If the user approved the content, the server marks the document or transaction as finalized and stores it in a persistent storage system, such as a document repository or transaction log, together with the associated authentication result and timestamps. If the user modified fields, the server replaces the affected fields in the structured data with the user-provided values and then marks the revised content as finalized.

Input: finalization message including approval status and any edited fields, and existing structured electronic document data or response content.

Output: finalized, authenticated structured records stored in persistent storage and optionally formatted documents ready for external transmission or archival.

The server thus completes a cycle in which generated content is optimized, authenticated, confirmed, and committed as reliable electronic data.

### Step 18:

The server constructs response data for user presentation after finalization. For a simple information query, the server encapsulates the cleaned response text in a response message. For a document-related task, the server embeds a summary, status flags such as “draft” or “submitted,” and, if appropriate, a link or identifier for downloading a generated electronic document. The server transmits the response data back to the terminal over the communication network.

Input: cleaned response text or finalized structured electronic document data, along with status information.

Output: response data message containing displayable content, status, and resource identifiers, sent to the terminal.

The server prepares the final user-facing output in a form tailored to the terminal's display and interaction model.

### Step 19:

The terminal receives the response data and parses it using the client application logic. The terminal updates its user interface to show the result: for example, the terminal may display “Tomorrow's weather in Tokyo will be sunny.” as a single message or may present a list of generated document items with options to download or share. The user views the displayed information, may download a file if provided, and may initiate a new interaction by entering another request.

Input: response data message from the server.

Output: a rendered user interface state displaying information or document links, and optionally new user input information when the user continues the interaction.

The terminal thus closes one processing cycle and may immediately start another, allowing the system to maintain an ongoing, efficient dialogue supported by structured prompts and generative AI model responses.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content generation systems that utilize generative artificial intelligence models often treat user input as a simple free-form query and pass it directly to the model without systematic normalization, prompt design, or feedback-driven adaptation. As a result, such systems may produce outputs that are inconsistent in quality, poorly aligned with user intent, and inefficient in their use of computational resources. For example, existing systems may generate unnecessarily long responses when only a brief summary is needed, may fail to adapt the style or depth of explanation to different user groups, or may repeatedly produce unsatisfactory results for the same type of user request because they do not effectively leverage user feedback.

Furthermore, in many existing approaches, the construction of prompt sentences for the generative artificial intelligence model is static and manually designed, and is not dynamically tuned based on accumulated interaction data. This limits the ability of the system to improve over time and to learn optimal prompt structures and generation parameters for different topics, keywords, or user segments. In addition, existing systems often lack a robust mechanism to post-process generated content for safety and suitability before delivery to the user, which can lead to delivery of inappropriate, low-quality, or irrelevant responses.

Thus, from a computer technology standpoint, there is a need for an improved content generation system that (i) programmatically normalizes and structures user input, (ii) automatically constructs and adjusts prompt sentences and generation parameters for a generative artificial intelligence model, (iii) performs systematic safety and quality post-processing on generated content, and (iv) collects and aggregates user evaluation information to adapt the behavior of the system over time. Such improvements can enhance the technical performance of the content generation pipeline executed by the processor, including improved control over model behavior, more efficient use of computing resources, and more relevant and consistent outputs.

The specific processing by the specific processing unit 290 of the data processing device 12 in Application Example 1 is realized by the following means.

The present invention provides a server comprising a processor configured to receive, from a user terminal, input information and perform verification and normalization of the input information; construct a prompt sentence for input to a generative artificial intelligence model by combining the normalized input information with a predefined instruction template and, optionally, with additional descriptors specifying at least one of an amount of explanation, a representation format, and a target audience; transmit the constructed prompt sentence and generation parameters to the generative artificial intelligence model via a communication path and obtain content data generated by the generative artificial intelligence model; perform post-processing on the obtained content data, the post-processing including at least a safety determination based on a predetermined criterion and removal of unnecessary portions, and transmit post-processed content data to the user terminal; and obtain evaluation information regarding the content data from the user terminal, store the evaluation information in a storage device, aggregate the evaluation information by statistical or learning-based processing, and update at least one of a structure of the prompt sentence, the instruction template, and the generation parameters on the basis of the aggregated evaluation information. This enables the server to execute an improved content generation process in which user input is systematically transformed into optimized prompt sentences, generated outputs are filtered and normalized for safety and quality, and subsequent interactions are dynamically adapted to user preferences and topical characteristics, thereby improving the technical functioning of the content generation system and enhancing the effectiveness and efficiency of the generative artificial intelligence model within a computer-implemented environment.

The term “processor” refers to a hardware or virtual processing unit, such as a central processing unit or an execution core in a computing environment, that executes instructions of one or more programs to perform the functions described herein.

The term “user terminal” refers to an information processing apparatus operated by a user, such as a mobile device, a personal computer, or a web client, that transmits input information to the system and receives content data from the system.

The term “input information” refers to data provided from the user terminal to the system, including at least a text string such as a topic or a keyword, and optionally including metadata such as a language preference, a content type, or a user identifier.

The term “verification” refers to a process performed by the processor to check that input information satisfies predetermined conditions, including at least conditions regarding presence, length, format, or encoding.

The term “normalization” refers to a process performed by the processor to transform the input information into a standardized internal representation, including at least trimming, character conversion, and removal or replacement of invalid or undesirable symbols.

The term “instruction template” refers to a predefined text pattern or rule set used by the processor as a basis for constructing a prompt sentence, the instruction template including at least one fixed instruction phrase and one or more insertion positions for the normalized input information or additional descriptors.

The term “prompt sentence” refers to a text sequence constructed by the processor by combining the instruction template with the normalized input information and optionally with additional descriptors, and supplied as an input to a generative artificial intelligence model in order to induce generation of content data.

The term “generative artificial intelligence model” refers to a machine learning model, such as a neural network model, configured to generate output data including natural language text in response to an input such as a prompt sentence and one or more generation parameters.

The term “generation parameters” refers to control values supplied to the generative artificial intelligence model, including at least one of a maximum output length, a randomness control value, a sampling control value, or a number of candidate outputs, that influence characteristics of the generated content data.

The term “content data” refers to information generated by the generative artificial intelligence model in response to a prompt sentence and generation parameters, including at least natural language text and optionally including structured data or metadata.

The term “post-processing” refers to processing performed by the processor on the content data obtained from the generative artificial intelligence model, including at least a safety determination and removal or modification of portions that do not satisfy predetermined criteria.

The term “safety determination” refers to an evaluation performed by the processor on the content data based on one or more predetermined rules or models, to determine whether the content data includes inappropriate, prohibited, or undesired information.

The term “unnecessary portions” refers to parts of the content data that are determined by the processor not to be needed for delivery to the user, including at least redundant text, formatting artifacts, or text segments that fail the safety determination.

The term “evaluation information” refers to information received from the user terminal that indicates a user's assessment of the content data, including at least one of a rating value, a selection of a preference indicator, or a comment.

The term “storage device” refers to any memory or recording apparatus, such as a non-volatile memory, a magnetic storage unit, or a database system, configured to store data including at least evaluation information, instruction templates, and generation parameters.

The term “statistical processing” refers to a computation performed by the processor to aggregate evaluation information, including at least calculation of counts, averages, distributions, or correlations with respect to one or more attributes of the content data or input information.

The term “learning-based processing” refers to a computation performed by the processor using a machine learning technique to derive or update a model or rule from evaluation information, in order to influence future construction of prompt sentences or selection of generation parameters.

The term “structure of the prompt sentence” refers to an arrangement or composition of elements within the prompt sentence, including at least an order, presence, or wording of instruction phrases, descriptors, and insertion positions for the normalized input information.

The term “topic” refers to a subject matter or theme indicated by the input information, which is used by the processor in constructing the prompt sentence and by the generative artificial intelligence model in generating content data.

The term “keyword” refers to a word or phrase contained in the input information that represents or specifies a topic, and that is used by the processor to tailor the prompt sentence or to identify a category of content generation.

The term “amount of explanation” refers to a desired degree of detail of the content data, such as a relative or absolute length, that is specified or implied in the prompt sentence and used by the generative artificial intelligence model when generating the content data.

The term “representation format” refers to a structural style of the content data, such as prose, a list, bullet points, or a question-and-answer form, that is specified in or derived from the prompt sentence.

The term “target audience” refers to a category of intended readers or users, such as beginners, intermediate users, or experts, that is specified in or derived from the prompt sentence and used to adjust the style, terminology, or depth of the content data.

The term “preferences of an individual user or a group of users” refers to tendencies inferred from evaluation information or interaction history, including at least favored topics, preferred representation formats, or desired amounts of explanation, that are used to adapt subsequent content data generation.

In one embodiment, a server cooperates with one or more terminals to implement a content generation system that utilizes a generative AI model. The server includes at least one processor, a main memory, a non-volatile storage device, a network interface, and an operating system such as a Unix-based system or a general-purpose server operating system. The terminal includes at least a processor, a display, an input device such as a keyboard or touch panel, a memory, and a communication module, and executes a client application, such as a web browser application (for example, an HTML/JavaScript browser) or a native mobile application.

The server executes an application program implemented, for example, using a server-side framework such as a Java-based web framework, a Python-based web framework, or a JavaScript-based web framework. The server program is stored in the non-volatile storage device and loaded into the main memory when executed by the processor. The program defines modules for input handling, prompt construction, model communication, post-processing, evaluation management, and adaptation.

The terminal executes a client program that provides a user interface. The terminal uses a graphical user interface toolkit, such as a browser rendering engine, a mobile user interface library, or a desktop user interface library, to render a text input component, selection components for specifying content type or target audience, and display components for presenting generated content. The terminal converts user operations on the input device into character strings encoded in a character encoding such as UTF-8, and stores these character strings in a memory structure such as a string buffer or an object property.

The server receives input information transmitted by the terminal via a communication protocol such as HTTPS over TCP/IP. The server parses a request message using a communication library corresponding to the server framework, and extracts a text field representing a topic or keyword, and optional metadata fields representing, for example, desired explanation length, representation format, or target audience type. The server stores the extracted values in data structures such as associative arrays, dictionaries, or structured objects in the main memory.

The server performs verification and normalization of the input information using string processing functions and validation routines. The server checks that the length of the input text is within a predetermined character range, that the text can be decoded as UTF-8, and that control characters or disallowed symbols are not included. The server normalizes the text by trimming leading and trailing whitespace, converting full-width characters to half-width characters where appropriate, and replacing or removing abnormal code points according to a table stored in the non-volatile storage device. The server thereby transforms various user-specific input formats into a standardized internal representation, which stabilizes later processing and reduces error conditions when communicating with the generative AI model.

The server constructs a prompt sentence for the generative AI model by combining the normalized input information with an instruction template stored in memory. The server stores one or more instruction templates as text strings or template objects. An instruction template includes, for example, a fixed instruction phrase and placeholders for insertion of user-provided topic or keyword and optional descriptors. The server selects an appropriate template based on the type of request or metadata and performs concatenation using string concatenation operations, format functions, or a template engine.

In one example, the server uses an instruction template such as:
“Generate content about: {topic}”
   and replaces “{topic}” with the normalized input information “the latest technology trends”, thereby constructing the following prompt sentence:
“Generate content about: the latest technology trends”

In another example, the server uses an instruction template including more detailed control of the generative AI model's behavior, such as:
“Generate a concise, beginner-friendly overview (about 600 words) of the latest technology trends, including AI, 5G, and quantum computing, using clear language suitable for non-experts. Write in Japanese. Topic: {topic}”
   and constructs a prompt sentence by substituting the input topic.

In a further example, the server constructs a prompt sentence to obtain structured bullet-point output:
“Generate a bullet-point list of the top 5 latest technology trends, each with a short explanation in Japanese and one concrete real-world example. Topic: the latest technology trends”

The server sets generation parameters, such as a maximum number of output tokens, a temperature value controlling randomness, a top-p sampling parameter, and a number of candidate outputs. The server stores default parameter values and parameter adjustment rules in the storage device, and modifies them dynamically based on the type of topic, past evaluation information, or system load conditions. By constraining and adjusting these parameters, the server reduces unnecessary token generation by the generative AI model, shortens processing time, and reduces network bandwidth usage.

The server transmits the constructed prompt sentence and generation parameters to the generative AI model via an external model service or an internal model execution module. In one embodiment, the server communicates with a remote generative AI model service that implements a transformer-based neural network. The transformer network internally includes multiple layers of multi-head self-attention modules and feedforward networks. Each self-attention module computes a weighted sum of token embeddings using attention weights derived from query, key, and value matrices. The server sends the prompt sentence to the model service via a REST-style or similar API using HTTPS, and receives generated content data in response.

In another embodiment, the server executes the generative AI model locally using a machine learning runtime library. The server stores a trained model in the storage device and loads it into memory. The model includes learned weights and bias parameters represented as arrays of floating-point numbers. The server performs forward propagation in the transformer layers by executing matrix multiplication operations, softmax functions, and non-linear activation functions on the processor or on an attached accelerator device such as a GPU. The server maintains a token buffer representing the prompt sentence and iteratively appends generated tokens by applying the model's probability distribution over vocabulary tokens at each time step.

The server thereby controls the data flow from the input information, through the constructed prompt sentence, into the transformer network, and back into content data represented as token sequences. The server decodes the token sequences into text strings using a tokenizer and character decoding functions. By explicitly structuring the prompt sentence and constraining the generation parameters, the server causes the transformer to focus its attention on relevant portions of the prompt and reduces unnecessary exploration in the token space, leading to shorter inference time and improved stability of generated outputs.

The server performs post-processing on the content data obtained from the generative AI model. The server uses string operations to remove leading and trailing whitespace and to normalize newline characters. The server executes a safety determination by applying rule-based filters and, optionally, a separate classification model. The rule-based filters search for prohibited words, patterns, or regular expressions stored in a rule database. The classification model may be a smaller neural network trained on labeled examples of acceptable and unacceptable text, using loss functions such as cross-entropy and weight updates performed by gradient descent during training. The server evaluates the content data against this model to obtain a probability score and compares the score to a threshold stored in the storage device. When the score indicates that safety is insufficient, the server either rejects the content data, requests a regeneration with modified parameters or prompt sentence, or replaces specific portions with alternative text.

The server also removes unnecessary portions of the content data that do not contribute to the user's requested purpose. The server may, for example, strip disclaimers that are automatically appended by the model, truncate sections beyond a preset length, or remove duplicated segments detected by similarity comparisons. These operations are implemented using substring extraction, hash-based duplicate detection, or token-level analysis. By pruning redundant or irrelevant segments, the server reduces the size of the message transmitted to the terminal and thus lowers communication load and improves display performance on the terminal.

The terminal receives the post-processed content data and renders it on the display. The terminal arranges the text into paragraphs, bullet lists, or headings, depending on the representation format specified in the prompt sentence and indicated by metadata returned by the server. The terminal can provide features such as scrolling, text search, and copying, implemented by the user interface library.

The user views the generated content and interacts with evaluation components displayed on the terminal. The terminal presents, for example, a star rating control, toggle buttons indicating preference, or a text input area for comments. The user operates these controls, and the terminal converts the operations into structured evaluation information. The evaluation information includes at least a content identifier, a user identifier or session identifier, a rating score, a binary like or dislike flag, and an optional free-form comment. The terminal encodes this information into a structured format and sends it to the server.

The server receives the evaluation information and stores it in a storage device such as a relational database or a key-value store. The server associates each evaluation record with the corresponding content data, prompt sentence identifier, instruction template used, and generation parameters. The server executes aggregation operations using database queries or numerical computation libraries. The server calculates, for example, average ratings per topic, distributions of representation formats that users prefer, and correlations between certain generation parameter settings and satisfaction levels.

The server applies learning-based processing to the aggregated evaluation information. In one embodiment, the server trains a simple predictive model that maps topic categories and generation parameter settings to expected satisfaction scores. The server uses a supervised learning method with a loss function measuring the difference between predicted and actual evaluation scores. The server updates model parameters by gradient descent or a similar optimization method. When new evaluation data arrives, the server periodically retrains or incrementally updates this model. The server then uses the resulting model to select or adjust generation parameters and prompt sentence structures for future content generation requests.

The server also updates instruction templates based on evaluation results. When the server detects, for example, that prompt sentences including explicit specification of target audience tend to receive higher ratings for a certain topic, the server adjusts the template selection rules so that such descriptors are more frequently included. When users repeatedly request more detailed explanations on a topic, the server extends or replaces the instruction template to increase the requested amount of explanation. This dynamic alteration of the internal templates and parameters constitutes a technical adaptation mechanism that changes the behavior of the system over time in response to empirical data, rather than simply automating a static human-designed process.

The system thereby improves computer technology in several respects. Because the server normalizes input information and constructs structured prompt sentences with explicit descriptors, the generative AI model receives more constrained and informative inputs. This reduces the entropy of the input token space and leads to faster convergence of the model's attention mechanisms during inference. Consequently, the server can reduce the number of tokens generated while maintaining or improving relevance, which shortens processing time and lowers computational load on the model hardware.

Because the server performs safety determination and removal of unnecessary portions before transmission to the terminal, the system avoids unnecessary retransmissions, user-side filtering, or manual corrections. This reduces network traffic and processing burden on the terminal processor, and reduces the risk of unpredictable behaviors caused by inappropriate content.

Because the server maintains and updates a mapping from topics and keywords to prompt sentence structures and generation parameters based on evaluation information, the system optimizes its internal parameter space in a data-driven manner. This adaptation is implemented as a specific algorithmic flow using measured evaluation signals, and is not merely a human operator adjusting parameters by trial and error. As a result, the server can provide higher accuracy in matching the style and depth of generated outputs to user expectations, while simultaneously reducing computational waste by avoiding ineffective parameter combinations.

In contrast to manual creation of prompts or simple forwarding of user input to a model, the described server uses a multi-stage processing pipeline that includes validation, normalization, template-based prompt construction, parameter selection, neural network inference, rule-based and learned safety filtering, and feedback-driven template and parameter adaptation. These processing steps are realized as computer-implemented modules that manipulate defined data structures, such as strings, token sequences, templates, evaluation records, and parameter vectors. The arrangement and cooperation of these modules result in a specific improvement to the functioning of computer systems that execute generative AI models, including improved response consistency, reduced average inference time, more efficient data transmission, and more effective utilization of stored evaluation data.

In alternative embodiments, the server may employ different generative AI model architectures, such as encoder-decoder transformers or recurrent neural networks, and may implement different tokenization schemes or embedding methods. The server may also distribute components across multiple physical machines, such as a front-end server for user communication and a back-end server for model inference, connected via an internal network. The terminal may be any computing device capable of displaying text, including, for example, a handheld device, a tablet, or a desktop workstation. Regardless of these variations, the core technical configuration in which the server constructs optimized prompt sentences, controls generation parameters, performs structured post-processing, and adaptively updates templates and parameters based on evaluation information remains the same and provides the described technical effects.

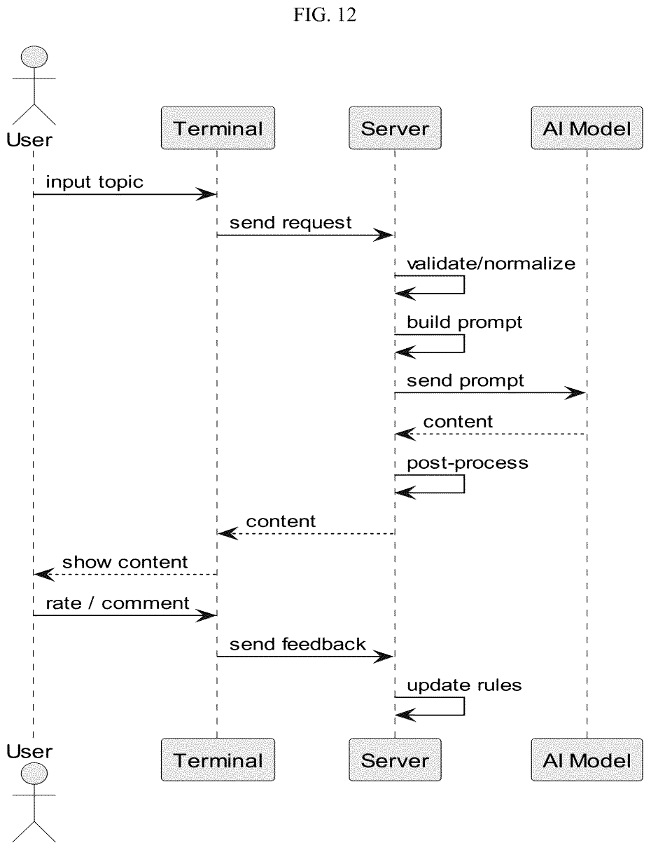

The following describes the processing flow using FIG. 12.

### Step 1:

The terminal presents an input interface on a display and receives input information from the user.

The terminal uses a text input field and optional selection controls (for example, drop-down menus or toggle buttons) to accept a topic or keyword, such as “the latest technology trends,” and optional metadata such as desired length or target audience.

As input, the terminal receives low-level user interactions (key presses, touch events) and converts them into a UTF-8 encoded character string and structured metadata.

The terminal performs local checks on the input, such as verifying that the text is not empty and that its length does not exceed a preset limit, and stores the validated text and metadata in a temporary data structure in memory.

As output, the terminal produces a structured request object containing at least the topic or keyword string and the associated metadata.

### Step 2:

The terminal transmits the structured request object to the server over a network connection.

As input, the terminal uses the request object produced in Step 1, including the text and metadata fields.

The terminal serializes the request object into a message, for example in JSON format, and invokes a communication library to send an HTTP or HTTPS request to a server endpoint.

The server receives the request via a network interface and passes the message to a server application for further processing.

As output, the terminal produces a network message containing the user's input information, and the server obtains the same information as a parsed request payload.

### Step 3:

The server validates and normalizes the input information received from the terminal.

As input, the server receives the parsed request payload that includes the topic or keyword string and metadata.

The server performs validation by checking that the text length is within a predefined range, that the encoding is valid UTF-8, and that prohibited control characters or invalid symbols are absent.

The server performs normalization by trimming leading and trailing whitespace, converting characters according to a normalization rule set (for example, full-width to half-width conversion or normalization of diacritical marks), and replacing or removing characters listed in an abnormal character table.

The server uses string manipulation functions and lookup tables stored in memory to carry out these data transformations.

As output, the server produces a normalized text string and a verified metadata set that are stored in internal variables or objects for subsequent processing.

### Step 4:

The server selects an instruction template and constructs a prompt sentence for a generative AI model based on the normalized input information.

As input, the server uses the normalized topic or keyword string and the verified metadata produced in Step 3.

The server determines an appropriate template by referencing a template selection rule set that maps request types or metadata combinations (such as “detailed explanation for beginners”) to template identifiers.

The server retrieves the selected instruction template, which is stored as a text pattern with placeholders, and combines the normalized text and relevant descriptors into the template using string concatenation or formatted substitution.

For example, the server may construct a prompt sentence such as “Generate content about: the latest technology trends” or “Generate a concise, beginner-friendly overview (about 600 words) of the latest technology trends. Topic: the latest technology trends.”

The server also determines generation parameters such as maximum token count, temperature, and top-p based on metadata and stored parameter profiles.

As output, the server produces a complete prompt sentence string and a parameter set adapted to the input characteristics.

### Step 5:

The server sends the prompt sentence and generation parameters to the generative AI model and obtains content data generated by the model.

As input, the server uses the prompt sentence and parameter set obtained in Step 4.

The server invokes an interface to the generative AI model, either by calling an external model service over a secure network protocol or by calling a local model execution module.

The server converts the prompt sentence into a sequence of tokens using a tokenizer, packages the token sequence and the parameter values into a request, and submits this request to the generative AI model.

The generative AI model, implemented for example as a transformer network with multiple attention layers, performs numerical operations including matrix multiplications and non-linear activations to compute probability distributions over output tokens and generates a sequence of tokens representing the content.

The server receives the generated token sequence and decodes it into a text string using a corresponding detokenization and character decoding process.

As output, the server produces raw content data in text form, along with any auxiliary information supplied by the model, such as confidence scores or token counts.

### Step 6:

The server performs post-processing on the raw content data to ensure safety, relevance, and compactness before delivery to the terminal.

As input, the server uses the raw content text and auxiliary information generated in Step 5.

The server applies a safety determination by running the text through rule-based filters and, optionally, a classification model that flags undesirable content. The server compares detected patterns against a stored list of prohibited tokens and evaluates classification scores against thresholds.

The server removes or masks flagged portions, and may trigger regeneration if the content fails safety criteria.

The server then removes unnecessary portions by trimming leading and trailing whitespace, deleting redundant phrases detected using substring matching or similarity measures, and truncating text that exceeds a maximum length defined by system settings or metadata.

The server can also structure the content into paragraphs, lists, or other formats according to the representation format indicated in the prompt or metadata.

As output, the server produces a cleaned and structured content text that satisfies safety and formatting constraints.

### Step 7:

The server transmits the post-processed content data to the terminal for presentation to the user.

As input, the server uses the cleaned and structured content text created in Step 6, and, optionally, associated metadata such as content identifiers and formatting hints.

The server encapsulates this information in a response message and sends it via an HTTP or HTTPS response through the network interface.

The terminal receives the response, parses the message using its communication and parsing modules, and extracts the content text and metadata fields.

As output, the server produces a network response containing finalized content data, and the terminal obtains an internal representation of the content ready for display.

### Step 8:

The terminal renders the received content on the display and provides controls for user evaluation.

As input, the terminal uses the content text and formatting hints obtained in Step 7.

The terminal uses its user interface toolkit to lay out paragraphs, bullet lists, and headings on the screen, and to attach interactive controls such as rating stars or like/dislike buttons to the displayed content item.

The user views the content and, if desired, interacts with the evaluation controls or a comment input area.

The terminal monitors user interactions, converts them into evaluation values (for example, an integer rating, a boolean flag, or a comment string), and stores them in a local data structure.

As output, the terminal produces a structured evaluation object associated with the displayed content identifier.

### Step 9:

The terminal transmits the evaluation information to the server for storage and analysis.

As input, the terminal uses the evaluation object generated in Step 8, including content identifier, evaluation values, and optionally user or session identifiers.

The terminal serializes this evaluation object into a request message, for example using JSON encoding, and sends it to a designated server endpoint via HTTP or HTTPS.

The server receives the message, parses the evaluation data, and validates that the referenced content identifier corresponds to a previously generated item.

As output, the terminal produces a network message conveying the evaluation information, and the server obtains the evaluation data as parsed fields.

### Step 10:

The server aggregates evaluation information and updates prompt construction rules and generation parameters for future requests.

As input, the server uses the newly received evaluation data from Step 9 and historical evaluation records stored in a storage device.

The server performs aggregation operations, such as computing average ratings per topic or per template, counting occurrences of low ratings, and correlating parameter settings with evaluation outcomes. The server uses database queries and numerical computations to produce these aggregates.

The server executes learning-based or rule-based algorithms that update internal tables of preferred templates, parameter profiles, and selection rules based on the aggregated evaluation metrics. For example, the server may increase the requested explanation length for topics that historically receive high ratings for more detailed answers, or may reduce temperature values for topics where users prefer more deterministic responses.

The server writes updated templates or parameter sets back to persistent storage so that subsequent executions of Step 4 and Step 5 automatically use the refined configurations.

As output, the server produces updated configuration data, including revised instruction templates and generation parameters, which directly influence how future prompt sentences are constructed and how the generative AI model is invoked.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information processing systems that provide responses to user inputs typically treat each input as an isolated query and do not effectively exploit stored user data such as personal attributes and historical behavior records in a systematic and secure manner. In many deployments, the server merely forwards raw user inputs to a generative AI model, or applies only simple keyword-based enrichment, without performing structured retrieval and contextual analysis of user-specific data. As a result, the generated responses are often generic, insufficiently personalized, and not well aligned with the user's long-term interests or actual usage context.

Furthermore, existing architectures generally lack a technical framework for integrating session-level authentication, identity-based access control to user data, and controlled provisioning of user-derived context to a generative AI model. In particular, there is no unified mechanism at the server level that (i) acquires user identification information, (ii) securely retrieves corresponding personal attribute information and behavior history information from storage, (iii) algorithmically analyzes such information in combination with current user input to construct a structured prompt sentence, and (iv) controls whether such a prompt sentence may be provided to the generative AI model based on an authentication result, including authentication based on biological information.

From a computer technology perspective, this lack of integration leads to several technical problems. First, server-side computing resources are inefficiently used because the generative AI model frequently processes under-specified prompts and must internally infer context that could have been explicitly supplied in a structured manner by the server. Second, network and storage subsystems are not optimized because user data is either underutilized or accessed in an ad hoc manner without clear linkage to a prompt-generation pipeline, causing redundant processing and increased latency. Third, security and privacy controls at the server and storage layers are not consistently enforced in conjunction with the generation and transmission of prompts to the generative AI model, which increases the risk of unauthorized access to sensitive data and unintended disclosure within prompts.

Accordingly, there is a need for an improved computer-implemented technique in which a server processor coordinates acquisition of user identification information, retrieval and analysis of user-related data, construction of a prompt sentence for a generative AI model, and controlled access based on authentication results, so that the overall information processing pipeline is technically enhanced. In particular, there is a need for a system that improves the functioning of the server and associated storage and communication subsystems by (i) reducing unnecessary computation within the generative AI model through more precise, context-rich prompt sentences, (ii) systematically structuring and reusing user data at the server side, and (iii) enforcing access control at the point where prompts are constructed and transmitted. Such a system should thereby provide more accurate and personalized responses while improving server efficiency, response latency, and security robustness at the computer system level.

The specific processing by the specific processing unit 290 of the data processing device 12 in Example 2 is realized by the following means.

The present invention provides a server comprising a processor configured to acquire user identification information and user input information including the user identification information via a communication interface; to access an information storage device based on the user identification information and acquire personal attribute information and behavior history information of a user stored in the information storage device; to analyze, by executing computer-executable instructions, the acquired personal attribute information and the behavior history information together with the user input information in order to determine at least one interest field and usage situation of the user and to generate a prompt sentence including instruction content for a generative information processing model, the prompt sentence being structured to explicitly encode the determined interest field and usage situation; to input the generated prompt sentence into the generative information processing model and cause the generative information processing model to generate response information based on the prompt sentence; and to convert the response information acquired from the generative information processing model into a format presentable to the user and output the response information to a terminal device through communication processing. This enables the server to improve computer functionality by reducing processing load within the generative information processing model through provision of context-rich prompts, by systematically utilizing stored user data to generate more relevant and personalized responses with reduced latency, and by enforcing technical controls over data access and prompt construction at the server level, thereby enhancing the overall efficiency, responsiveness, and security of the information processing system.

The term “user identification information” refers to information that distinguishes one user from another within a system, including but not limited to an account identifier, a login identifier, or other authentication-related data that is used as a key to access user-related records in an information storage device.

The term “user input information” refers to information that is explicitly provided by a user through an input interface of a terminal device, including natural language queries, commands, or selections, and that may include user identification information associated with the user.

The term “information storage device” refers to a hardware and software combination capable of storing and retrieving digital data, including databases, file systems, and other persistent storage subsystems that hold personal attribute information and behavior history information of users.

The term “personal attribute information” refers to information representing characteristics of a user that are relatively stable over time, such as demographic attributes, preferences, settings, or profile-related data, which are stored in an information storage device and associated with user identification information.

The term “behavior history information” refers to information representing past actions or interactions of a user with applications or services, including search queries, accessed content, selected items, or transaction records, which are stored in an information storage device and associated with user identification information.

The term “generative information processing model” refers to a computational model, such as a machine-learned model, that receives a prompt sentence as input and generates new information, including text or other media, by probabilistically or deterministically producing output data based on learned parameters.

The term “prompt sentence” refers to a structured natural language or symbolic instruction that is constructed by the server and provided as input to a generative information processing model, the instruction including contextual information, such as user interests or usage situations, to guide generation of response information.

The term “response information” refers to information generated by a generative information processing model in response to a prompt sentence, including recommended items, explanations, summaries, plans, or other content that is suitable to be presented to a user.

The term “terminal device” refers to an information processing apparatus operated by a user, including but not limited to a portable information processing apparatus, a stationary information processing apparatus, or a web-enabled apparatus, that transmits user input information to a server and presents response information to the user.

The term “interest field” refers to a category or topic of information that is inferred to be of importance or relevance to a user based on personal attribute information, behavior history information, or both, and that is encoded into a prompt sentence to bias generation by a generative information processing model.

The term “usage situation” refers to a context or condition under which a user interacts with a system, including temporal context, recent activity, type of requested service, or device context, which is derived from user input information, personal attribute information, or behavior history information.

The term “biological information” refers to information related to physical or physiological characteristics of a user, such as biometric patterns, that can be used for identity verification or authentication of the user.

The term “authentication processing device” refers to a computing apparatus or subsystem that performs authentication of a user based on identification information, including biological information, and that outputs an authentication result usable by a server for access control.

The term “public authentication function” refers to an authentication capability implemented according to a public or standardized authentication scheme, including government-certified or industry-standard mechanisms, which provides an authentication result that can be relied upon to control access to protected resources.

In one embodiment, a server cooperates with one or more terminal devices used by a user to provide personalized response information generated by a generative AI model. The server includes a processor, a main memory, a non-volatile storage device, and a network interface. The terminal includes a processor, a main memory, a display, an input device, and a network interface. The user operates an application program, such as a messaging application or a search interface, on the terminal.

The server stores a program in the non-volatile storage device. When the processor of the server executes the program, the processor realizes functional modules including: a communication module, an authentication cooperation module, a user data acquisition module, a user data analysis module, a prompt generation module, a generative model interface module, and a response formatting module. The terminal stores a program that causes the terminal to provide an input user interface and an output user interface, and to exchange messages with the server.

The server uses the communication module to receive user input information and user identification information from the terminal through the network interface. The user identification information includes an account identifier or another identifier associated with user records stored in an information storage device. The server uses a database management system, for example a relational database system or a document database system, executing on the server hardware, as the information storage device to store user-related data. The information storage device stores personal attribute information and behavior history information for a plurality of users in structured records. For example, the information storage device stores a user profile table with fields representing demographic categories and preference categories, and an action history collection with fields representing timestamps, action types, query strings, and item identifiers.

The server uses the authentication cooperation module to cooperate with an external or internal authentication processing device. In one embodiment, the terminal acquires biological information of the user, such as a biometric pattern, and transmits an authentication token to the server. The server transmits authentication data to the authentication processing device that has a public authentication function, receives an authentication result, and stores a session state in a session store. Based on the authentication result, the server grants or denies access to the information storage device and to the generative AI model interface. This configuration improves technical security control within the computer system by preventing unauthorized access to stored data and by preventing unauthorized prompt sentences from being provided to the generative AI model.

The server uses the user data acquisition module to access the information storage device and to obtain personal attribute information and behavior history information linked to the user identification information. The server uses database drivers and query execution engines of the database management system to retrieve records from the storage device into main memory. The server represents the retrieved data as in-memory data structures, such as arrays of records and key-value maps, and indexes the behavior history information by timestamp and category. The server optionally employs secondary indexes in the database to reduce disk access and to improve retrieval latency. This structured retrieval process reduces the number of disk I/O operations and improves the throughput of the server.

The server uses the user data analysis module to process the personal attribute information and the behavior history information stored in main memory. The server applies a sequence of deterministic operations that include filtering, normalization, categorization, aggregation, and feature extraction. For example, the server removes events that fall outside a configurable time window, normalizes query strings to a standard character set, and tokenizes the query strings into word tokens or phrase tokens using a text analysis library. The server categorizes actions into topic categories, such as travel, education, health, or finance, by applying a rule-based classifier or a trained lightweight classifier that uses features derived from token frequencies and metadata. The server computes statistics such as term frequency, recency-weighted frequency, and co-occurrence values for tokens and categories. The server derives feature vectors representing user interests by combining these statistics into numerical vectors.

In one embodiment, the server stores, in memory, for each user, a user interest profile as a vector of dimension N, where each dimension corresponds to a topic category or a keyword cluster. The server updates the vector by applying a decay function to older events and incrementing values for recent events. This explicit representation of user interests as a machine-usable data structure reduces repeated analysis for each new request and improves processing speed. The server further determines a usage situation by analyzing the current user input information and correlating it with recent behavior history information. For example, if the current input mentions “next vacation” and recent queries relate to travel destinations, the server sets the usage situation to a “travel planning” context and restricts the behavior history considered in subsequent steps to travel-related actions within a recent period.

The server uses the prompt generation module to construct a prompt sentence based on the analyzed user data and the current user input information. The server receives as input the user interest profile, the usage situation, and the original natural language text supplied by the user. The server applies a non-trivial template selection and filling algorithm. In one embodiment, the server selects a prompt template from a set of stored templates indexed by usage situation and dominant interest category. Each template is a text pattern with placeholders for specific elements such as examples of past actions, inferred skill levels, or preference constraints. The server chooses a template that matches the “travel planning” usage situation and a “beach resort” interest field, and then fills placeholders with specific data derived from the behavior history information.

For example, the server generates a prompt sentence such as:
“The user has previously searched for beach resorts like Okinawa and Hawaii and for snorkeling tours. The user now asks for recommended destinations for the next vacation. Please generate 5 beach resort destinations worldwide that match this interest, with short reasons, best travel seasons, and approximate budget ranges.”

In another example, when the user frequently reads content about data science and machine learning and inputs a query about what to learn next, the server generates a prompt sentence such as:
“The user has frequently read articles about machine learning basics, Python tutorials, and introductory statistics. The user now asks: ‘What should I learn next in data science?’ Assume the user is at an intermediate level. Please propose a six-month learning roadmap with concrete topics, recommended study order, and example resources.”

The server encodes the prompt sentence as a character string using a specific character encoding format and stores the string in memory. Unlike a simple concatenation of the user input and a generic instruction, the server includes structured user context in the prompt sentence, such as representative past queries and inferred levels, using a rule set that specifies which behavioral signals are included and how they are abstracted. This rule set is designed so that the prompt sentence maximizes informational density while limiting the length, thereby improving the efficiency of the downstream generative AI model.

The server uses the generative model interface module to communicate with a generative AI model. In one embodiment, the generative AI model is a neural network-based language model deployed on dedicated hardware comprising graphics processing units or tensor processing units. The generative AI model may have a transformer architecture with multiple self-attention layers, feedforward layers, and normalization layers. The model parameters are obtained by pre-training on large text corpora using an objective function such as next-token prediction, and optionally fine-tuning on domain-specific data. The server transmits the prompt sentence, model identifier, generation parameters such as maximum output length, temperature, and top-k or top-p sampling thresholds, to the generative AI model via an application programming interface over a secure transport protocol.

The server uses the generative model interface module not only to forward the prompt sentence but also to configure the generative AI model's behavior for each request. For example, the server adjusts the maximum output length based on the user's device type or bandwidth conditions and modifies the sampling parameters to trade off determinism and diversity depending on the usage situation. By performing this per-request configuration at the server level, the system reduces unnecessary token generation and improves computational efficiency on the model side. The server also logs model response times and token counts and uses these logs to adjust future parameter choices to maintain a target latency threshold.

The generative AI model receives the prompt sentence and processes it by converting the sequence of tokens into internal vector representations, propagating these vectors through the transformer layers, and iteratively generating output tokens according to the learned probability distribution. The model computes a loss function during training, such as cross-entropy between predicted token distributions and ground truth tokens, and updates parameters using gradient-based optimization methods with techniques like learning rate schedules, regularization, and data augmentation. During inference, the model applies only the forward pass, using the previously trained parameters. The model generates response information in the form of token sequences that are converted back to text. By providing a richer, structured prompt sentence that includes explicit user interests and context, the server causes the model to reduce the search space of plausible outputs and to converge more quickly to high-quality responses. This results in fewer decoding steps, reduced computational load, and improved response accuracy.

The server uses the response formatting module to process the response information received from the generative AI model. The server parses the response text and, if necessary, segments the text into paragraphs, bullet lists, or sections based on detected patterns. The server may perform validation or post-filtering, for example filtering out content categories not permitted by system policy. The server converts the processed text into a representation compatible with the terminal, such as a markup structure or a structured message format, and transmits the result to the terminal through the communication module.

The terminal receives the response information, renders the text using a graphical user interface framework, and displays the content on the display device. The terminal can adapt layout and font size to the screen characteristics and can provide interactive elements such as buttons that trigger follow-up requests. The user views the response information and may provide additional input to refine the request. The terminal again sends updated user input information and the same user identification information to the server, enabling iterative refinement using the same technical pipeline.

This configuration yields technical effects beyond mere automation of human mental tasks. By maintaining a structured user interest profile, by applying non-trivial feature extraction and template-based prompt construction rules, and by dynamically configuring generative model parameters, the server reduces the computational burden on the generative AI model, improves cache locality and memory access patterns in the information storage device, and decreases the number of network round trips required to obtain an acceptable response. The server thereby shortens end-to-end latency as measured from user input to display of the response. Moreover, the server's control over which user-related data is included in the prompt sentence, combined with authentication-based gating of storage access and model invocation, improves technical privacy and security properties at the system level.

In another embodiment, the server applies additional algorithms for weighting behavior history information. The server may compute a recency-weighted moving average for each interest category, where weights decay exponentially over time, and may maintain separate short-term and long-term profiles. The server may also apply clustering algorithms to group related query terms into clusters, and may map clusters to higher-level categories used in prompt templates. This layered representation allows the system to adapt to changes in user behavior without recomputing the entire profile for every request, thereby improving computational efficiency.

In yet another embodiment, the generative AI model is deployed locally within the same data center as the server, and the server controls allocation of processing resources to the model by adjusting batch sizes and scheduling requests. The server may queue prompt sentences and group them into batches for parallel processing on the accelerator hardware, improving throughput and hardware utilization. The server may also prioritize requests from authenticated users with certain profiles, implementing a resource management policy at the infrastructure level.

In a further embodiment, the server uses the same architecture to handle different domains, such as address change procedures, travel planning, and learning roadmap generation. For address change procedures, the server uses personal attribute information such as user region and contract type, and behavior history information such as previously accessed forms, to generate a prompt sentence that describes the specific conditions required for the address change. The generative AI model generates document information or instructions needed for the address change. This domain-specific usage still leverages the same technical pipeline: structured retrieval, profile-based analysis, template selection, and parameterized model invocation, resulting in improved technical performance regardless of the business domain. The system can be realized using different hardware and software variations. The server may execute an operating system such as a general-purpose server operating system, application server software, and database management software. The generative AI model may be a third-party model accessed via an external service, or may be a proprietary model trained and deployed within a private environment. The terminal may be a smartphone, tablet, personal computer, or other network-capable device. In all such variations, the essential feature is that the server's processor executes an integrated sequence of computer-implemented operations that transform stored user data and immediate user input information into a structured prompt sentence and controls the use of that prompt sentence with a generative AI model, thereby improving the operation of the computer system as a whole.

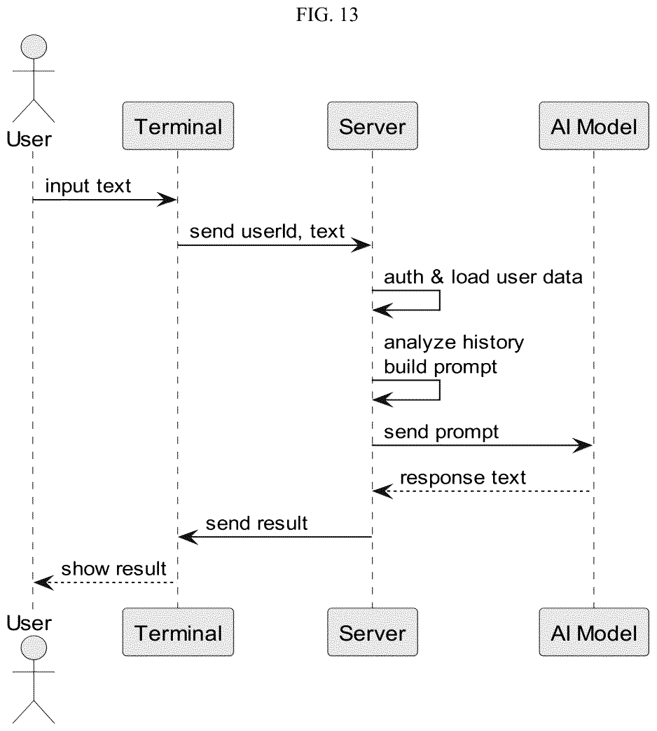

The following describes the processing flow using FIG. 13.

### Step 1:

The user operates an application on the terminal and enters user input information.

The terminal displays an input screen and accepts text (for example, “Tell me recommended destinations for my next vacation”) and login credentials or account selection from the user.

The terminal uses the input device to capture the character sequence and the user identifier, and constructs an internal data object containing the user input text and user identification information.

Input: keystrokes or touch input, account selection, login credentials.

Output: a structured user input object that includes a user ID and a text string representing the user's request.

### Step 2:

The terminal transmits the user input object to the server.

The terminal serializes the user input object into a message format and sends the message to the server via a network interface using a secure transport protocol.

The terminal attaches session information or authentication tokens if available.

Input: the structured user input object including user ID, text, and session information.

Output: a network message delivered to the server that encodes the user ID, the request text, and session-related data.

### Step 3:

The server receives and validates the user input object.

The server uses the network interface to accept the message from the terminal and parses the serialized data into internal variables (for example, userId, requestText, sessionToken).

The server uses an authentication cooperation module to verify the session token or to query an authentication processing device for an authentication result.

Input: the network message containing user ID, request text, and authentication data.

Output: validated user identification information, validated user input text, and a Boolean flag indicating whether the user is authenticated.

### Step 4:

The server retrieves user-related records from an information storage device.

The server uses the validated user identification information as a lookup key and issues database queries to a database management system.

The server reads personal attribute information (for example, stored preferences, region data) and behavior history information (for example, past queries, clicked items) into main memory as arrays and maps associated with the user ID.

Input: user identification information and access permission (authentication flag).

Output: a set of records representing personal attribute information and a set of records representing behavior history information for the identified user.

### Step 5:

The server filters and normalizes the behavior history information.

The server applies time-window filters to exclude records older than a configured threshold and removes system-generated or duplicate events.

The server normalizes text fields by converting characters to a standard form, splitting text into tokens, and removing stop words or non-informative symbols.

Input: raw behavior history records retrieved from the database.

Output: a cleaned and normalized list of behavior records ready for analysis, each record containing standardized tokens, timestamps, and action types.

### Step 6:

The server analyzes the cleaned behavior history information to compute user interest features.

The server counts occurrences of tokens and categories, applies recency weights to more recent actions, and aggregates counts into numerical values for topic categories.

The server constructs a user interest profile vector by assigning each category or keyword cluster a dimension and filling that dimension with a calculated score.

Input: normalized behavior history records.

Output: a user interest profile represented as a structured data object (for example, a vector or dictionary) that quantifies the user's interests across multiple categories.

### Step 7:

The server determines the current usage situation from the user input information and recent behavior history.

The server parses the current request text to extract keywords (for example, “vacation,” “address change,” “learning plan”) and matches these keywords against a set of predefined usage situation rules.

The server examines the most recent behavior history records in combination with the current keywords to classify the current interaction into a usage situation category such as travel planning, personal information update, or education planning.

Input: current user input text and recent normalized behavior history records.

Output: a usage situation label and a subset of behavior history information that is most relevant to the current situation.

### Step 8:

The server selects a prompt template based on the usage situation and dominant interest category.

The server evaluates the user interest profile to identify the category with the highest score that is compatible with the usage situation (for example, “beach resorts” in the travel planning situation).

The server retrieves a corresponding template pattern from a template store, where each pattern includes placeholders for interest descriptions, past actions, and the current user request.

Input: usage situation label and user interest profile.

Output: a selected template pattern that specifies the structure of the prompt sentence and associated placeholder positions.

### Step 9:

The server fills the selected template with concrete information to generate a prompt sentence.

The server selects representative examples from the relevant behavior history subset, such as frequently searched destinations or topics, and inserts them into placeholders.

The server inserts inferred attributes, such as user level (for example, beginner, intermediate) or preference constraints (for example, beach preference), and appends the current user request text.

Input: the selected template pattern, the relevant behavior history subset, and the current user input text.

Output: a complete prompt sentence, encoded as a character string, that describes user interests, context, and explicit instructions to the generative AI model.

### Step 10:

The server configures generative AI model parameters and sends the prompt sentence to the generative AI model.

The server determines generation parameters such as maximum output length, sampling temperature, and diversity thresholds based on the usage situation, the user's device type, and current system load.

The server encapsulates the prompt sentence and the determined parameters into a request message and transmits the message to the generative AI model endpoint.

Input: the generated prompt sentence and configuration policies for the generative AI model.

Output: a model invocation request that includes the prompt sentence and specific numerical parameters controlling the model's inference behavior.

### Step 11:

The generative AI model generates response information based on the prompt sentence.

The generative AI model receives the prompt sentence, tokenizes it, and converts tokens into vector embeddings using its learned embedding matrix.

The generative AI model propagates these vectors through a transformer architecture with multi-head self-attention layers and feedforward layers, repeatedly computing attention weights and transformed representations to predict each subsequent token according to a trained probability distribution.

Input: tokenized prompt sentence and generation parameters from the server.

Output: a sequence of output tokens that represent response information tailored to the prompt sentence, subsequently converted to a text string.

### Step 12:

The server receives and post-processes the response information.

The server accepts the generated text from the generative AI model and verifies the integrity of the response (for example, checking for truncation or error codes).

The server parses the text to identify structural elements such as lists, sections, or headings, and may reformat these elements for better readability or to comply with device-specific constraints.

Input: raw response text output from the generative AI model.

Output: a formatted response object containing structured text and optional metadata for display on the terminal.

### Step 13:

The server transmits the formatted response object to the terminal.

The server serializes the formatted text and metadata into a response message and sends the message through the network interface to the terminal.

The server may include additional flags indicating priority or recommended layout types.

Input: the formatted response object.

Output: a network response message that encapsulates the text and layout hints for the terminal.

### Step 14:

The terminal renders the response information and presents it to the user.

The terminal receives the response message, deserializes the text and metadata, and constructs a user interface view using its graphical rendering engine.

The terminal arranges the text into chat bubbles, lists, or other visual components on the display, and may create interactive elements that enable the user to request further details or refinements.

Input: the response message containing formatted text and metadata.

Output: a visual presentation on the display and an interactive interface through which the user can view and respond to the generated information.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented service systems that generate documents, recommendations, or user interface adaptations from user inputs typically treat user data, behavioral history, and emotional state as separate, loosely coupled resources. A conventional server generally receives raw form data from a terminal, performs fixed rule-based lookups in data repositories, and, if any generative AI model is used at all, passes a simplistic text instruction to such a model without systematically encoding structured context, historical behavior, or real-time emotional state into a prompt sentence. As a result, the generated outputs often lack accuracy, consistency, and personalization, leading to increased manual correction by the user, inefficient transaction flows, and poor user experience.

Furthermore, conventional systems do not effectively leverage modern data processing pipelines to transform heterogeneous logs and profile records into machine-learning-ready features that can be combined with generative AI outputs. For example, existing workflows often fail to use robust preprocessing of history information with data processing software, classical machine learning software for behavioral tendency analysis, and dedicated emotion estimation software in a coordinated fashion. This fragmented architecture makes it difficult for the computer system to automatically synthesize context-rich prompt sentences for a generative AI model and therefore limits the technical performance and reliability of AI-assisted document generation and input assistance.

In addition, existing address-change and similar administrative procedures remain largely static and form-centric from the computer's perspective. Even when certain fields are auto-filled, the server does not dynamically generate a full-text notification or application document tailored to the user's history and emotional state, nor does it reuse submission results as structured history data to improve subsequent interactions. This lack of feedback into the computational pipeline prevents continuous improvement of recommendation quality, prompt quality, and automation coverage.

Moreover, identity verification is often implemented as a separate security layer that does not influence the internal logic of AI prompt generation or document finalization. Conventional servers may validate credentials or biometric information, but they do not use authentication results to control which information is included in a prompt sentence to a generative AI model, when a document is considered final, or how strictly the system enforces consistency checks. Consequently, the reliability of the entire AI-assisted workflow is constrained by the weakest link between authentication and content generation, and the computer system cannot fully optimize its internal processing based on the level of assurance about the user's identity.

Accordingly, there is a need for a computer-implemented system that technically improves the way a processor (i) acquires and enriches user input information via a terminal, (ii) preprocesses and analyzes user history information and emotional state using dedicated software components, (iii) programmatically constructs rich prompt sentences for a generative AI model from this analyzed context, and (iv) integrates the model's generated text with templates and external processing flows in a manner that is controlled by authentication results. Such a system should reduce computational waste, improve the accuracy and completeness of generated documents and recommendations, streamline user interface control, and enhance the overall reliability and effectiveness of AI-assisted service provision on a computer network.

The specific processing by the specific processing unit 290 of the data processing device 12 in Application Example 2 is realized by the following means.

The present invention provides a server comprising a processor configured to (i) provide, via a terminal, an input/output interface for acquiring user input information and to receive, from the terminal, text information, selection information, and identifier information associated with a communication function or an information retrieval function used by the user; (ii) acquire, on the basis of the identifier information and the user input information, history information and attribute information of the user from a storage device or an external information providing apparatus, preprocess the acquired information by using data processing software, analyze a behavioral tendency of the user by using machine learning software, estimate an emotional state of the user by using emotion estimation software, and thereby supplement information required for service provision; (iii) generate, on the basis of the supplemented information and the emotional state, context information including at least a task type, a required document type, candidate recommendation information, and user interface control information, and construct a prompt sentence in natural language to be input to a generative AI model; (iv) transmit the prompt sentence to the generative AI model via a network, receive generated text from the generative AI model, parse the generated text to extract document data, recommendation data, or user interface control data, and automatically execute document generation processing or input assistance processing by combining the extracted data with template data; (v) transmit the document data, the recommendation data, or the user interface control data to the terminal, cause the terminal to present the data to the user, receive modification operations or confirmation operations from the user via the terminal, update the document data or related data on the basis of contents of the operations, and, when necessary, regenerate a prompt sentence for re-input to the generative AI model; and (vi) after final confirmation by the user, transmit the document data or transaction-related data to an external processing apparatus, store a transmission result as history information, and reflect the history information in subsequent information supplementation processing and prompt sentence generation processing. This enables the computer system itself to more effectively utilize user history, behavioral analysis, and emotional state in generating context-rich prompt sentences and in interpreting generative AI outputs, thereby improving the technical performance of automated document generation, recommendation, and user interface adaptation, reducing the need for manual correction, and enhancing the reliability and efficiency of AI-assisted transactions.

The term “processor” refers to a hardware computation unit, or a combination of such units, configured to execute instructions of one or more software components to perform the operations described herein.

The term “terminal” refers to a user-operated information processing apparatus, such as a mobile device, a tablet device, or a general-purpose computing device, that executes a client application and exchanges data with the server via a communication network.

The term “input/output interface” refers to a software-implemented user interface, presented on the terminal, that enables the acquisition of user input information and the presentation of output information to the user.

The term “user input information” refers to information explicitly provided by a user through the terminal, including text information, selection information, and other interaction data entered into the input/output interface.

The term “text information” refers to character-based data, including natural language sentences, keywords, and form fields, input by the user or generated by the system.

The term “selection information” refers to data indicating a choice made by the user, including menu selections, option toggles, button activations, and other discrete user interface selections.

The term “identifier information” refers to information that uniquely or semi-uniquely associates a user interaction with a particular communication function or information retrieval function, such as an account identifier, application identifier, or session identifier.

The term “communication function” refers to a software function or service that enables the exchange of messages or signals between the user and one or more other entities via a communication network.

The term “information retrieval function” refers to a software function or service that enables querying, searching, or browsing of information resources stored locally or remotely over a communication network.

The term “storage device” refers to any memory component or data storage apparatus, including local storage and remote storage, configured to store history information, attribute information, templates, and other data used by the processor.

The term “external information providing apparatus” refers to an information processing system outside the server that supplies data to the server via a communication network, such as an external database system or an external service system.

The term “history information” refers to data representing past interactions of the user, including transaction records, search logs, document submission logs, and prior behavior records.

The term “attribute information” refers to profile-related data about the user, including demographic information, account properties, preferences, and other relatively static or slowly changing user characteristics.

The term “data processing software” refers to a software component configured to perform operations such as data loading, cleansing, transformation, aggregation, and normalization on one or more datasets.

The term “machine learning software” refers to a software component implementing one or more algorithms that derive patterns or models from data, including classification, regression, clustering, recommendation, or other predictive or analytical models.

The term “behavioral tendency” refers to a pattern of user actions inferred from history information, such as preferences, typical selections, or likely future actions, as determined by the machine learning software.

The term “emotion estimation software” refers to a software component configured to analyze input data, such as text, interaction logs, or other signals, to infer an emotional state of the user.

The term “emotional state” refers to a classification or parameterization of the user's affective condition, such as anxious, excited, relaxed, in a hurry, or other emotional categories.

The term “service provision” refers to the overall set of computer-implemented operations by which the system generates documents, recommendations, user interface adaptations, or transaction-related outputs for the user.

The term “context information” refers to a structured aggregation of data describing the current situation of the user and system, including at least a task type, a required document type, candidate recommendation information, and user interface control information.

The term “task type” refers to a classification of the current user task to be supported by the system, such as document generation for an application, address change processing, transaction execution, or recommendation presentation.

The term “required document type” refers to a classification of a document that must be generated or processed for the current task, such as a notification document, an application document, or a transaction document.

The term “candidate recommendation information” refers to data representing one or more items, services, or options that may be proposed to the user for selection, based on history information and behavioral analysis.

The term “user interface control information” refers to data specifying how elements of the user interface should be arranged, emphasized, simplified, or otherwise modified in response to system logic or user state.

The term “prompt sentence” refers to a natural language instruction, or a set of such instructions, constructed by the processor and provided as input to a generative AI model to cause the model to generate desired output content.

The term “generative AI model” refers to a trained computational model configured to generate text or other content in response to a prompt sentence, based on learned statistical relationships in training data.

The term “network” refers to a communication infrastructure, including wired or wireless links and intermediary nodes, that enables data transfer between the server, the terminal, and external apparatuses.

The term “generated text” refers to text output produced by the generative AI model in response to a prompt sentence supplied by the processor.

The term “document data” refers to data representing content of a document to be created, filled, or updated by the system, including but not limited to forms, notifications, and applications.

The term “recommendation data” refers to data describing one or more recommended items, services, or actions to be presented to the user, including identifiers, descriptions, and explanatory text.

The term “user interface control data” refers to data specifying operations to be applied to the user interface, such as layout changes, element visibility, or interaction flow adjustments.

The term “template data” refers to predefined structured data defining a skeleton or format of a document or user interface, including placeholders to be filled with dynamically generated or retrieved content.

The term “document generation processing” refers to processing operations that create or update document data by combining template data with generated text or other content.

The term “input assistance processing” refers to processing operations that support or automate the filling of input fields, the completion of forms, or the guidance of user entries based on system-generated suggestions.

The term “modification operations” refers to actions performed by the user through the terminal to change, correct, or supplement contents of generated documents or other outputs.

The term “confirmation operations” refers to actions performed by the user through the terminal to approve, accept, or finalize contents of documents, recommendations, or other outputs.

The term “transaction-related data” refers to data necessary for performing or recording a transaction, including transaction parameters, parties, amounts, and associated document identifiers.

The term “external processing apparatus” refers to an external information processing system that receives document data or transaction-related data from the server and performs further processing, such as adjudication, registration, or settlement.

The term “authentication processing apparatus” refers to an external or internal information processing system configured to verify the identity of a user based on biometric information, credentials, or other authentication information.

The term “authentication protocol” refers to a defined communication and verification procedure specifying how authentication information is exchanged and validated between the server, the terminal, and the authentication processing apparatus.

The term “biometric information” refers to data derived from a physical or behavioral characteristic of a user, such as a fingerprint pattern, facial image, voice pattern, or similar characteristic, suitable for use in identity verification.

The term “authentication information” refers to data used to prove a user's identity, including passwords, tokens, cryptographic credentials, or biometric information.

The term “authentication result” refers to information output by the authentication processing apparatus indicating a success or failure state, or a level of confidence, in identifying the user.

The term “final confirmation” refers to an explicit approval action by the user, received via the terminal, that instructs the system to treat a document or transaction as ready for external submission or execution.

The term “history information” (as stored after transmission) refers to structured records of previous transmissions of document data or transaction-related data, including timestamps, destinations, and outcomes, that are used as input for future processing steps.

The term “information supplementation processing” refers to a sequence of operations in which the processor enriches current user input information using stored history information, attribute information, and external data to fill missing or incomplete fields.

The term “prompt sentence generation processing” refers to a sequence of operations in which the processor constructs one or more prompt sentences intended for input to the generative AI model, based on context information and prior results.

In one embodiment, a server cooperates with at least one terminal operated by a user to implement the claimed system. The server comprises at least one processor, a main memory, a non-volatile storage device, and a network interface coupled to a communication network. The terminal comprises a computation unit, a memory, a display, and an input unit such as a touch panel, keyboard, or microphone. The terminal executes a client application implemented for example using a cross-platform framework (such as a JavaScript-based mobile framework) or a web browser running a user interface library (such as a component-based JavaScript library).

The server executes an application program implemented in a general-purpose programming language such as Python or Java. In one embodiment, the server uses a web framework such as a Python HTTP framework to expose REST endpoints, a data processing library such as a table-based analysis library (for example, a library providing a DataFrame abstraction like Pandas), and a machine learning library such as a classical machine learning toolkit (for example, a library similar to Scikit-learn). The server uses one or more deep learning frameworks (for example, a framework similar to TensorFlow) to implement emotion estimation functions, and uses a neural-network-based generative AI model accessed through an API. The server stores user history and profile data in a relational database management system such as a SQL-based database, and may also use a document-oriented data store for product catalogs or template definitions.

The terminal provides an input/output interface to the user. The terminal displays input fields, selection elements, and guidance messages, and the user enters text such as name, address, free-form queries (for example, “camping tent” or “moving stress”), and selects task types (for example, “tax return,” “address change,” or “credit card application”). The terminal acquires identifier information associated with a communication function or an information retrieval function, for example an application identifier, an account identifier, or a session identifier, and packages this identifier information together with the user's input into a structured message, such as a JSON-like object, and transmits it to the server over an encrypted transport protocol.

The server receives the user input information and identifier information, and the server performs structured data processing internally. The server maps the received data into an internal data structure, such as a nested dictionary or an object having fields for user profile, session context, and raw text. The server uses the identifier information as a key to retrieve history information and attribute information from the storage device and, if needed, from an external information providing apparatus through standardized APIs. The history information may include a table of previous transactions with attributes such as timestamps, amounts, item categories, and completion status. The attribute information may include a profile table storing address, demographic attributes, and preference scores.

The server uses the data processing library to load the history information into a DataFrame structure. The DataFrame includes columns such as user identifier, event type, timestamp, item identifier, category, numeric values (for example, prices), and derived metrics (for example, frequency counts, recency scores). The server performs deterministic data transformations, including imputation of missing values, normalization of numeric columns, categorical encoding of textual categories, and aggregation of events into per-user feature vectors. By representing user behavior in a dense numerical feature space, the server reduces memory usage and improves cache locality compared to ad hoc data traversal, thereby improving processing speed and computational efficiency.

The server uses machine learning software to analyze behavioral tendencies. In one embodiment, the server trains a recommendation model using a matrix factorization algorithm or a gradient-boosted decision tree algorithm on the feature vectors extracted from the DataFrame. The model receives as input a feature vector that includes, for example, a user index, item index, interaction frequency, and derived emotional scores, and outputs a predicted preference score for each item. The server uses a loss function such as mean squared error or cross-entropy over historical interactions, and uses a gradient-based optimization algorithm to update model parameters. The server may periodically retrain the model offline, storing trained parameters (for example, factor matrices or tree structures) in the storage device, and load them into memory for online inference. This model-based processing differs from human manual selection because the server evaluates thousands of items in multi-dimensional feature space in milliseconds, which a human cannot feasibly perform, thereby technically improving recommendation throughput and scalability on the computing system.

The server uses emotion estimation software to infer an emotional state of the user. In one embodiment, the server implements a neural network classifier configured to process text tokens from user messages and search queries. The server tokenizes the text into subword units, maps each token to an embedding vector, and supplies a sequence of embeddings to a recurrent neural network (such as a long short-term memory network) or a transformer-based encoder. The network includes multiple layers of non-linear transformations and attention mechanisms, and outputs a fixed-length representation, which is then passed through a dense layer with a softmax activation to produce probabilities over emotion classes, such as “anxious,” “excited,” “in a hurry,” or “relaxed.” The server trains this network using a training dataset of messages labeled with emotion categories, a categorical cross-entropy loss function, and an optimizer such as stochastic gradient descent with momentum or an adaptive gradient method. During inference, the server uses optimized tensor operations on a central processing unit or a graphics processing unit to compute emotion probabilities for each new message in a fixed number of operations, improving both accuracy and latency compared to rule-based sentiment heuristics.

In another embodiment, the server uses an external emotion estimation service through an API. The server sends text or interaction features to the service and receives an emotion label and intensity scores. The server stores the emotion label in the session context data structure. The combination of classical behavioral models and emotion classification allows the server to assign more informative state vectors to each session, which leads to more precise downstream control of document generation and user interface behavior.

The server constructs context information based on the supplemented information and emotional state. The context information may include the task type (for example, “address change procedure”), required document type (for example, “notification document” or “application document”), candidate recommendation information (for example, recommended auxiliary services or items), and user interface control information (for example, whether to simplify the flow for a user in a hurry). The server serializes this context information into a natural-language prompt sentence for a generative AI model. The prompt sentence is not a fixed template; instead, the server programmatically composes it from specific feature values and states. For example, the server may generate the following prompt sentences: “Based on this user's search for ‘camping tent’ and past purchases of outdoor gear, and considering that the user is feeling anxious, propose three practical camping products that will make the trip easier and reduce stress. Provide short explanations in Japanese.”

“Using the following user information (name, current address, new address, income, employment status), generate a complete Japanese housing loan application form text suitable for submission to a Japanese bank. Clearly state any fields that cannot be filled.”

“Using the user's name, current address, and date of birth, generate a Japanese credit card application form text, filling any fields that can be inferred from the data. Use a formal style suited for a credit card issuer.”

“The user wants to change address to ‘Tokyo-to Shinjuku-ku Nishi-Shinjuku 2-8-1.’ In Japanese, list all standard administrative procedures required for an individual resident to change address in Tokyo, and generate the texts for the necessary notification forms.”

The server computes these prompt sentences by concatenating fixed instruction segments with dynamically computed components such as the task type, emotional state, missing fields, and specific values extracted from the DataFrame and neural network outputs. This composition logic is algorithmic and uses explicit conditions and loops in the program code, thereby creating a repeatable mapping from internal data structures to external prompt sentences. By controlling exactly which fields enter the prompt and how they are phrased, the server constrains the generative AI model's behavior to a narrower and more technically useful region of its output space. This improves determinism and reduces downstream correction overhead, which is a technical effect on the computing system's overall execution.

The server sends the prompt sentence to the generative AI model via the network interface. The generative AI model is implemented, for example, as a multi-layer transformer architecture trained on large-scale text data. The model comprises an embedding layer, multiple self-attention layers with multi-head attention, feed-forward sublayers, and a final linear projection to a vocabulary space. For each inference, the model receives the prompt sentence tokenized into token identifiers, and iteratively computes successive hidden states and token probability distributions. The model selects output tokens using greedy decoding or beam search until a termination condition is met. The server accesses this model through an inference API and configures model parameters such as maximum token length and sampling temperature. Because the model runs on dedicated compute infrastructure, such as parallelized GPU clusters, the server offloads high-complexity language generation tasks, which results in stable latency and predictable resource usage on the server itself.

The server receives the generated text from the generative AI model and parses the output to extract document data, recommendation data, and user interface control data. In one embodiment, the server instructs the model in the prompt sentence to use a constrained textual structure, for example indicating headings or delimiters, which the server then splits using deterministic parsers. The server maps extracted segments into fields of internal document structures or recommendation lists. The server then combines these fields with template data stored in the storage device. For document generation, the server uses template layouts in a markup format that contain placeholders for variables such as name, address, amounts, item names, and explanatory paragraphs. The server replaces each placeholder with a specific value from the parsed output or from previously stored profile data, and then renders the result into a document format suitable for display or transmission, such as HTML or a standardized document representation.

The server transmits the resulting document data, recommendation data, and user interface control data to the terminal. The terminal renders the document in an editable view, and presents recommendations as structured lists. The terminal interprets user interface control data to change layout, such as highlighting primary action buttons when the user is “in a hurry,” or expanding explanatory text when the user is “anxious.” This dynamic adaptation based on computed emotion state and machine-derived prompts provides an improved user interface behavior that cannot be achieved by static rule-based scripts alone. The terminal only executes rendering operations based on data received from the server and does not replicate the complex analysis logic, which reduces processing load on resource-constrained devices.

The user reviews the generated documents and recommendations on the terminal. The user may correct specific fields, such as editing an address or adjusting a loan amount, and may accept or reject recommended items. The terminal records these modifications and confirmations and sends them back to the server as structured updates. The server updates the corresponding entries in its data structures and, when necessary, regenerates a new prompt sentence that explicitly states the modifications, such as:
“The user changed the loan amount from 20,000,000 yen to 25,000,000 yen; update the summary and repayment schedule accordingly in the previously generated housing loan application text, while preserving all other fields.”

By re-invoking the generative AI model with an incrementally updated prompt, the server ensures that dependent sections of the document (such as totals, summaries, or explanatory remarks) remain internally consistent, reducing human error and ensuring that the machine enforces referential integrity across text segments in a manner similar to relational constraints in databases.

When an operation requires identity verification, the terminal collects biometric information or authentication information, such as a fingerprint scan or passcode. The terminal uses hardware-specific APIs to acquire encrypted biometric templates and sends authentication tokens to the server. The server relays these tokens to an authentication processing apparatus implementing a standardized authentication protocol. The server receives an authentication result and updates the session state to reflect an assurance level. The server then uses this assurance level to control both prompt content and document finalization. For example, if the authentication is not yet successful, the server omits sensitive fields from the prompt sentence, thereby preventing the generative AI model from accessing or reproducing certain personal identifiers. Only after successful authentication does the server include full identifiers and mark the document as eligible for external submission. This conditional gating of model input and document finalization ties security state directly into the AI pipeline and improves reliability and safety of the computer system.

After final confirmation by the user, the server transmits finalized document data or transaction-related data to an external processing apparatus, such as an external transaction server or registration system, using a standardized data exchange protocol. The server records the external submission result (for example, a reference number and timestamp) as part of the history information. In subsequent sessions, the server incorporates this new history information into the DataFrame structures and model inputs, enabling improved prediction of required documents and likely user actions. By treating history as structured training and inference data rather than merely archival logs, the server continuously refines its internal computational behavior, producing more precise prompt sentences and more accurate generative outputs over time.

The described architecture produces technical effects beyond automation of human tasks. The integration of DataFrame-based preprocessing, classical machine learning, neural-network-based emotion estimation, and structured prompt sentence generation reduces redundant data retrieval operations, concentrates relevant features into fixed-size vectors, and narrows the generative AI model's output space to semantically appropriate regions. This results in lower network bandwidth usage between server and terminal due to fewer iterative corrections, and reduces the number of calls to external generative AI services due to higher-quality initial prompts. The neuromorphic emotion classifier and recommendation model operate with optimized numerical routines, improving inference throughput and latency compared to naive string-matching approaches. The joint use of authentication results to gate prompt content and document finalization also reduces the risk of inconsistent or unauthorized outputs, thereby improving the robustness of the complete computing system.

In alternative embodiments, the server may use different machine learning algorithms, such as convolutional neural networks for processing image-based input, or may replace the transformer-based generative AI model with another generative architecture, such as a recurrent neural network with attention. The terminal may be a desktop computer, a smart appliance, or an embedded device in a kiosk. The storage device may be a distributed file system or a cloud-based key-value store. The emotion estimation may incorporate additional modalities, such as acoustic features extracted from audio streams or temporal patterns of user interaction. In each case, the server still constructs prompt sentences from structured context information and uses the generative AI model as a constrained generative component embedded within a broader deterministic pipeline of data preprocessing, feature computation, and rule-based control. Such variations remain within the scope of the claimed system, as they preserve the essential structure by which the server enriches user input, computes behavioral and emotional features, programmatically generates context-rich prompt sentences, and integrates generative outputs with templates and authentication-controlled workflows to realize improved technical performance in automated document generation, recommendation, and user interface control.

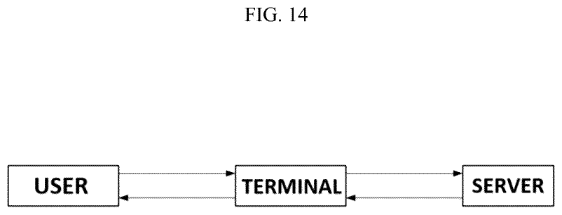

The following describes the processing flow using FIG. 14.

### Step 1:

User operates the terminal to provide initial input.

User enters text information (for example, name, address, query text such as “camping tent” or “moving stress”) and selects a task type (for example, “address change,” “tax return,” or “credit card application”) through the input/output interface displayed on the terminal.

Input: Raw user keystrokes, touch events, and selection events.

Output: A structured local data object on the terminal containing fields such as ‘user_text’, ‘task_type’, ‘selected_options’.

### Step 2:

Terminal assembles and sends a request to the server.

Terminal acquires identifier information associated with a communication function or information retrieval function (for example, an application identifier, account identifier, or session identifier) and combines it with the structured local data object. Terminal converts this combined data into a serialized request body (for example, a JSON-like structure) and transmits it via an HTTP POST over an encrypted network connection to a predefined server endpoint.

Input: Local data object (‘user_text’, ‘task_type’, etc.) and identifier information.

Output: A network request message containing user input information and identifier information, delivered to the server.

### Step 3:

Server receives and normalizes the request data.

Server listens on the endpoint using a web framework and parses the incoming request body. Server validates required fields, normalizes encodings (for example, converts text to UTF-8), and maps the received values into an internal data structure such as a session context object with subfields for raw input, identifiers, and timestamps.

Input: Serialized network request from the terminal.

Output: In-memory session context object on the server containing normalized user input information and identifier information.

### Step 4:

Server retrieves history information and attribute information.

Server uses the identifier information in the session context as keys to query one or more storage devices or external information providing apparatuses. Server issues database queries (for example, SQL SELECT statements) to obtain tables of past transactions, search logs, document submissions, and stored profile attributes such as registered address and contact data. Server may call external APIs to obtain additional profile information if available.

Input: Session context object containing identifier information.

Output: History information and attribute information loaded into memory as structured records or tables.

### Step 5:

Server preprocesses history information using data processing software.

Server loads the history information into a DataFrame structure provided by a data processing library. Server performs data transformations such as type casting, missing value imputation (for example, replacing null address fields with previous known values), normalization of numeric columns (for example, scaling monetary amounts), and categorical encoding of text categories (for example, mapping product categories to integers). Server then aggregates events per user or per task into feature vectors by computing counts, recency scores, and averages.

Input: Raw history information records from the storage device.

Output: Cleaned and feature-enriched DataFrame and per-user feature vectors representing behavioral patterns.

### Step 6:

Server analyzes behavioral tendency using machine learning software.

Server supplies the per-user feature vectors to a trained machine learning model (for example, a matrix factorization model or a gradient-boosted decision tree model) loaded into memory. Server computes predicted preference scores or relevance scores for candidate items or document types by performing numerical operations defined by the model parameters (for example, vector-matrix multiplications and tree traversals). Server then ranks items or document types according to these scores.

Input: Feature vectors derived from the DataFrame.

Output: A ranked list of candidate recommendation items and/or relevant document types for the current session.

### Step 7:

Server estimates the emotional state of the user.

Server extracts text segments from user input information (for example, query phrases, message content) and optionally interaction features (for example, time intervals, frequency of edits). Server tokenizes the text and passes a sequence of tokens to an emotion estimation module, which may be a neural network model or an external emotion service. The model computes embedding vectors, processes them through network layers, and outputs probabilities for emotion classes. Server selects the class with highest probability and stores the result in the session context as the current emotional state.

Input: User text and interaction-derived features from the session context.

Output: An emotional state label (for example, “anxious,” “excited,” “in a hurry,” or “relaxed”) with associated confidence scores.

### Step 8:

Server compiles context information for prompt construction.

Server combines task type, required document type (either selected by the user or inferred from the machine learning model), ranked candidate items, and emotional state into a context structure. Server also includes indicators of missing or uncertain fields (for example, income not provided, new address incomplete). Server organizes this context into a deterministic format, such as a dictionary with keys for task, emotion, candidates, and missing fields, to be used in the next step.

Input: Session context object, ranked candidates, and emotional state label.

Output: Context information object describing the current computational situation and requirements.

### Step 9:

Server generates a prompt sentence for the generative AI model.

Server converts the context information object into a natural-language instruction by concatenating predefined template phrases and inserting specific values from the context. Server may choose different wording patterns depending on task type and emotion (for example, providing more explanatory instructions when the user is “anxious”). Server completes a full prompt sentence such as: “Using the following user information (name, current address, new address, income, employment status), generate a complete Japanese housing loan application form text suitable for submission to a Japanese bank. Clearly state any fields that cannot be filled.”

Input: Context information object including task type, user attributes, ranked candidates, emotional state, and missing fields.

Output: A context-rich prompt sentence in natural language, prepared for input to the generative AI model.

### Step 10:

Server calls the generative AI model with the prompt sentence.

Server transmits the prompt sentence through an API client to the generative AI model hosted on an external or internal inference system. The model tokenizes the prompt, processes tokens through its internal layers, and generates output tokens until completion. Server receives the generated text as a string or as a sequence of tokens, and associates it with the session.

Input: Prompt sentence constructed in Step 9.

Output: Generated text from the generative AI model, corresponding to document content, recommendations, or guidance.

### Step 11:

Server parses and structures the generated text.

Server analyzes the generated text using parsing rules, delimiters, or patterns specified in the prompt. Server splits the text into segments representing document body, item list, explanations, or user interface instructions. Server maps each segment into defined data fields: for example, filling document data fields (name, address, sections), recommendation data fields (item identifiers, descriptive sentences), and user interface control data fields (flags for showing or hiding elements).

Input: Raw generated text from the generative AI model.

Output: Structured document data, recommendation data, and user interface control data.

### Step 12:

Server combines structured data with templates.

Server selects an appropriate template from the storage device based on the task type and required document type. Server replaces placeholders in the template (for example, {NAME}, {NEW_ADDRESS}, {LOAN_AMOUNT}, {EXPLANATION_PARAGRAPH}) with the corresponding fields from the structured document data and, where applicable, from stored attribute information. For recommendations, server composes a list or grid layout specification from the recommendation data. For user interface control, server builds a configuration object indicating layout changes and interactions.

Input: Structured document data, recommendation data, user interface control data, and template data.

Output: Fully composed document content, formatted recommendation list, and user interface configuration, ready for delivery to the terminal.

### Step 13:

Server performs optional authentication-dependent control.

Server checks whether the task requires strong authentication (for example, address change submission or credit card application). If so, server marks the session state as “authentication required” and prepares a message prompting the terminal to initiate biometric or credential-based authentication. Server may also create a restricted variant of the document that masks sensitive fields until authentication succeeds.

Input: Task type, session policy rules, and composed document data.

Output: Authentication requirement flag and, optionally, a restricted version of the output data.

### Step 14:

Terminal executes user authentication when requested.

Terminal receives the authentication requirement from the server and presents a prompt to the user to provide biometric information or credentials. Terminal interacts with local hardware (for example, fingerprint sensor or camera) and operating system APIs to capture an authentication sample. Terminal sends an authentication token or response to the server via a secure channel.

Input: Authentication requirement and user's biometric or credential input.

Output: Authentication token or result message sent to the server.

### Step 15:

Server validates authentication and adjusts processing.

Server forwards the authentication token to an authentication processing apparatus or verifies it internally if possible. Server receives an authentication result and updates the session context with authentication status. If authentication succeeds, server un-masks sensitive fields in the document data and records that the output may be finalized. If authentication fails, server may limit or block further processing, or adjust the next prompt sentence to request additional verification information.

Input: Authentication token from the terminal and authentication result from the authentication processing apparatus.

Output: Updated session context with authentication status and potentially modified document data or control flow.

### Step 16:

Server sends final or draft outputs to the terminal.

Server packages the document content, recommendation list, and user interface configuration into a response payload. Server includes flags indicating whether the content is a draft or is eligible for final submission. Server sends this payload to the terminal over the network.

Input: Composed outputs and authentication status from the session context.

Output: Response message containing document data, recommendation data, and user interface configuration delivered to the terminal.

### Step 17:

Terminal displays outputs and collects user feedback.

Terminal renders the document content in a scrollable and editable view, displays recommendations with descriptive text and selection controls, and modifies the layout based on the user interface configuration (for example, showing simplified flows for “in a hurry” users). User reviews the content, edits fields as needed, and performs actions such as accepting, rejecting, or confirming specific items.

Input: Response message from the server.

Output: Updated user actions, edited field values, and confirmation signals on the terminal.

### Step 18:

Terminal transmits user modifications and final confirmation.

Terminal constructs an update payload containing any modified document fields, changes to recommendation selections, and a flag indicating whether the user is saving a draft or performing final submission. Terminal sends this payload to the server over the network.

Input: Edited document data and user confirmation status from the terminal UI.

Output: Update request with modifications and finalization status delivered to the server.

### Step 19:

Server applies modifications and optionally revises content.

Server merges the received modifications into its stored document data and session context. When the modifications affect dependent fields (for example, changing a loan amount that influences repayment calculations), server may generate a new prompt sentence describing the changes and call the generative AI model again to update affected text segments. Server then re-composes the document content with the corrected fields.

Input: Update request with modified fields and finalization flag.

Output: Updated and internally consistent document data, and, if revised, updated generated text.

### Step 20:

Server finalizes and transmits to external processing apparatus.

When the finalization flag indicates that the user has confirmed submission and authentication status is sufficient, server marks the document as final. Server sends the finalized document data or transaction-related data to an external processing apparatus using an agreed protocol, receives a response (for example, a receipt or reference number), and records this result in history information.

Input: Finalized document data and transaction-related data.

Output: External submission result stored in history and a status result prepared for return to the terminal.

### Step 21:

Terminal presents completion status to the user.

Terminal receives a final status message from the server, which includes confirmation, reference identifiers, and any follow-up instructions. Terminal displays this information to the user and may archive a local copy or allow the user to download a representation of the submitted document.

Input: Final status message from the server.

Output: Visual confirmation of completion shown to the user and optional local record on the terminal.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

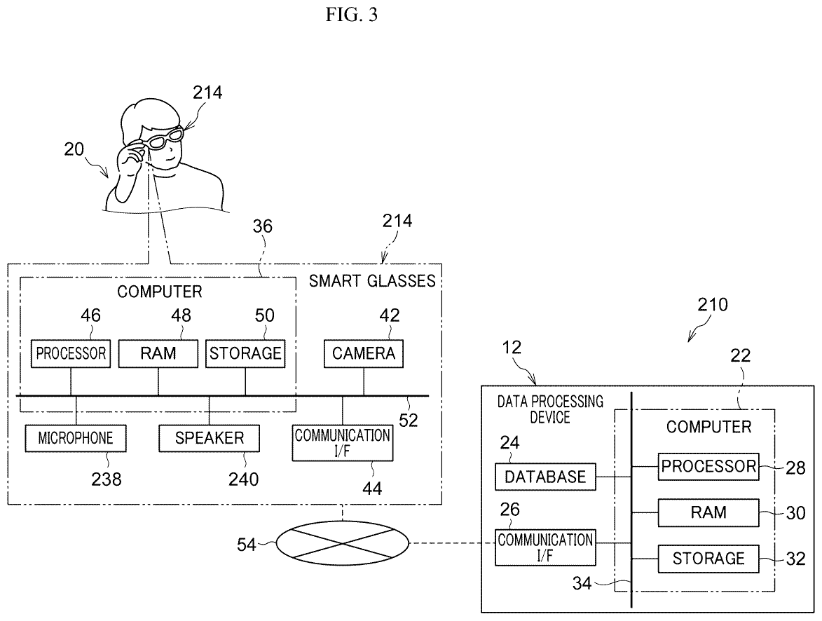

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

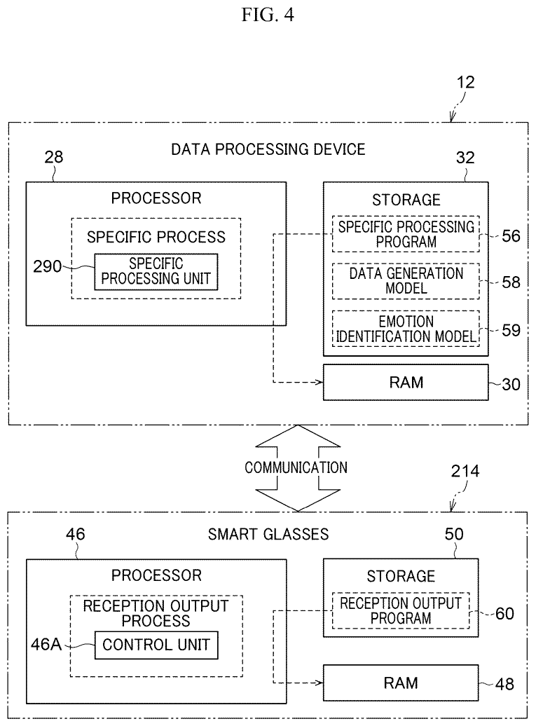

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

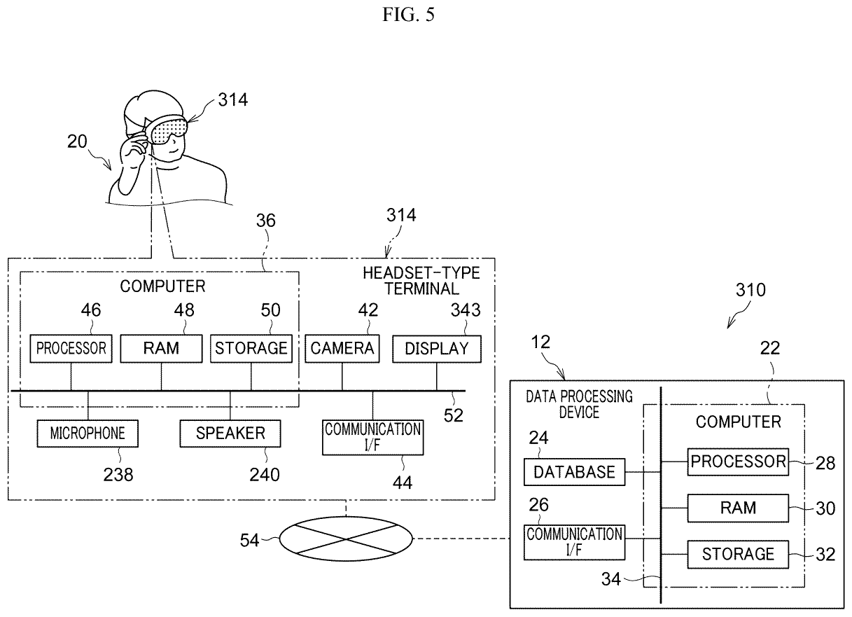

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

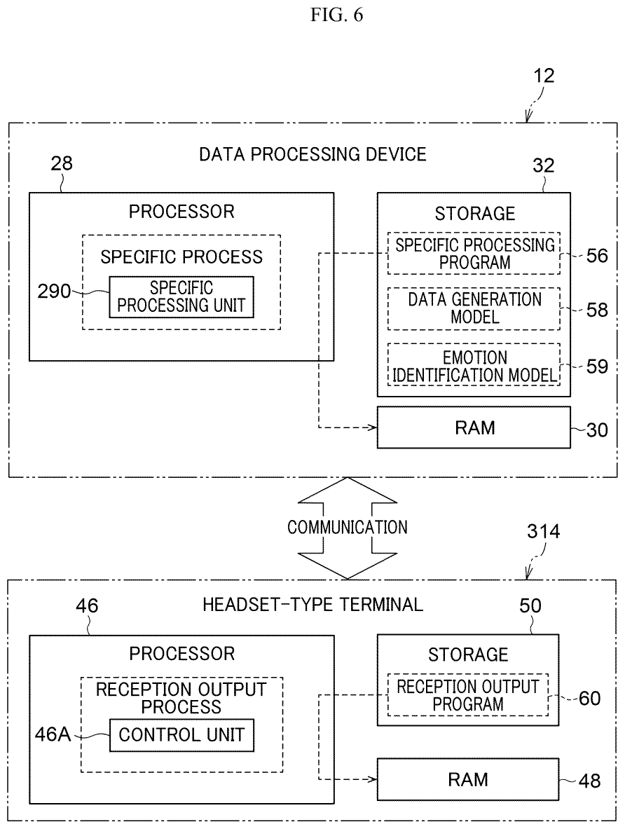

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

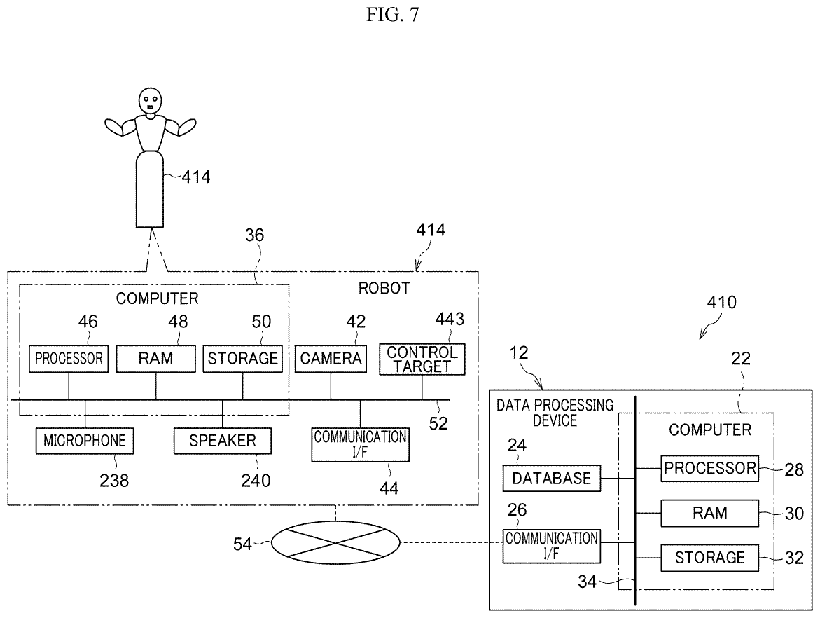

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

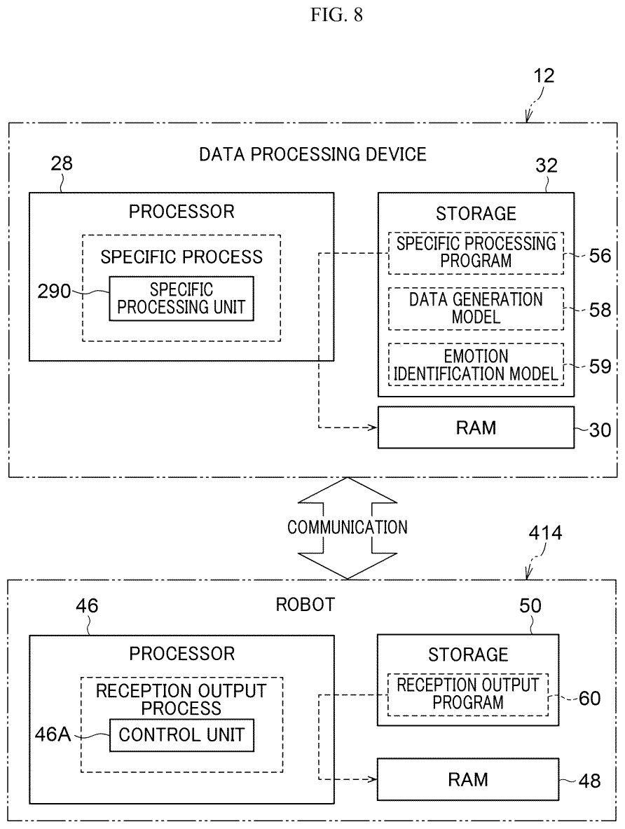

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

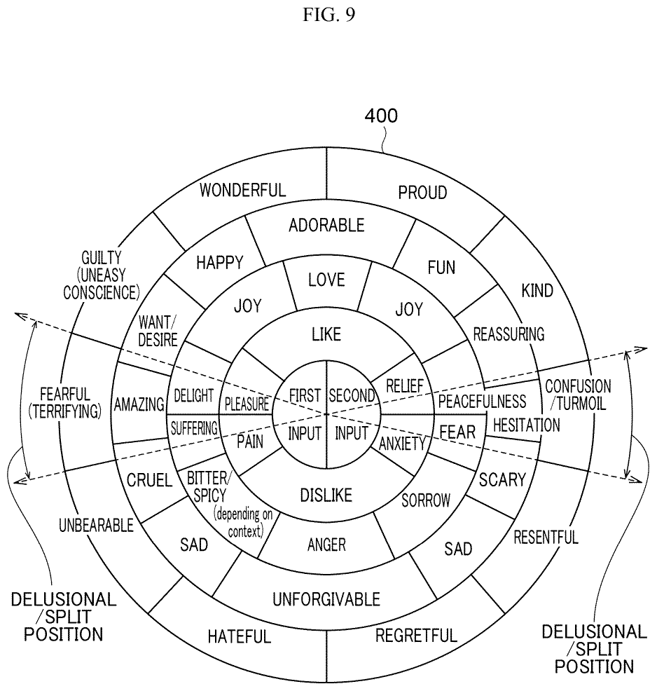

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

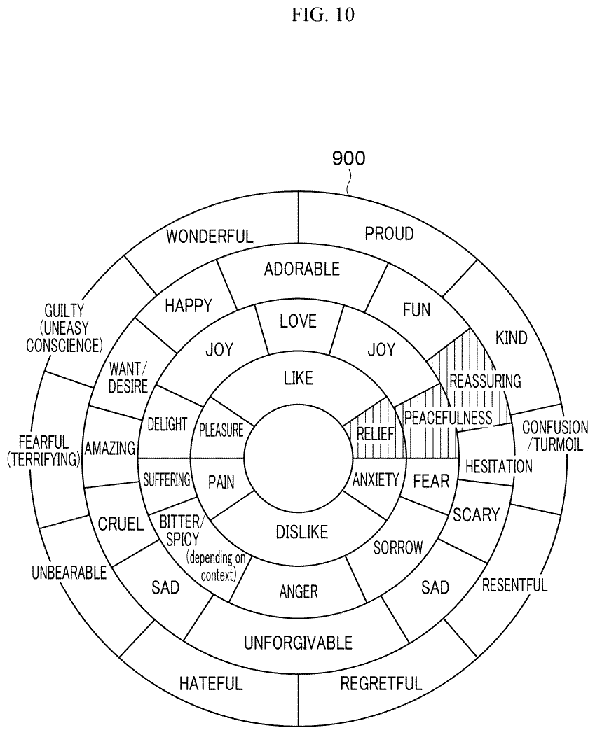

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, from an information processing terminal via a communication network, user input information and application identification information,
perform natural language processing on the user input information to extract a user request and related items, acquire complementary information including time information, region information, user attribute information, and past dialogue history information based on the extraction result and the application identification information, and organize the user input information as structured data,
generate a prompt sentence including dialogue history information and response style conditions on the basis of the structured data and the complementary information, adjust the prompt sentence so that the prompt sentence falls within a predetermined word count or symbol count range, and input the prompt sentence to a generative information processing model,
perform post-processing on response information obtained from the generative information processing model by unifying an expression format, adjusting a language type, and removing unnecessary information, and, when necessary, integrate the response information with additional information acquired from an external information providing apparatus to generate response data, and
transmit the response data to the information processing terminal and provide the response data as screen display data or electronic document data.

### (Supplementary 2)

The system according to supplementary 1,
wherein the processor is configured to, when it is determined that the user request included in the structured data is related to a change of residential information, generate and input to the generative information processing model a prompt sentence including a body text candidate and an input item candidate for a document used in a residential information change procedure, and automatically generate or complement a description region in an application-form template by using the response information obtained from the generative information processing model.

### (Supplementary 3)

The system according to supplementary 1,
wherein the processor is configured to, before finalizing application content or transaction content included in the response data generated based on the user input information, receive biometric authentication information and authentication information transmitted from the information processing terminal, verify user identity in cooperation with a public authentication apparatus or an authentication management apparatus, generate display information for content confirmation by using a verification result and the response data, and present the display information again to the information processing terminal so as to improve reliability of authentication and certainty of content confirmation.

### Application Example 1

### (Supplementary 1)

A system comprising a processor,
wherein the processor is configured to
receive input information transmitted from a user terminal and perform verification and normalization of the input information,
construct a prompt sentence for input to a generative artificial intelligence model by combining the normalized input information with a predefined instruction template, transmit the constructed prompt sentence and generation parameters to the generative artificial intelligence model via a communication path and obtain content data from the generative artificial intelligence model,
perform post-processing on the obtained content data, the post-processing including at least a safety determination based on a predetermined criterion and removal of unnecessary portions, and transmit post-processed content data to the user terminal, and
obtain evaluation information regarding the content data from the user terminal, store the evaluation information in a storage device, and update at least one of the instruction template and the generation parameters on the basis of the evaluation information.

### (Supplementary 2)

The system according to supplementary 1,
wherein the processor is configured to
receive, as the input information from the user terminal, at least one of a topic and a keyword, and add, to the prompt sentence, a description specifying at least one of an amount of explanation, a representation format, and a target audience corresponding to the topic or the keyword, so as to control a level of detail and a format of an output generated by the generative artificial intelligence model.

### (Supplementary 3)

The system according to supplementary 1,
wherein the processor is configured to
aggregate the evaluation information by statistical processing or learning processing, and dynamically change at least one of a structure of the prompt sentence and the generation parameters corresponding to a specific topic or a specific keyword, so as to adapt subsequent content data generated by the generative artificial intelligence model to preferences of an individual user or a group of users.

### Example 2

### (Supplementary 1)

A system comprising a processor,
wherein the processor is configured to
acquire user identification information and receive user input information including the user identification information,
access an information storage device based on the user identification information and acquire personal attribute information of the user and behavior history information of the user stored in the information storage device,
analyze the acquired personal attribute information and the behavior history information together with the user input information and generate a prompt sentence including instruction content for a generative information processing model in accordance with an interest field and a usage situation of the user,
input the generated prompt sentence into the generative information processing model and instruct the generative information processing model to generate response information based on the prompt sentence, and
convert the response information acquired from the generative information processing model into a format presentable to the user and output the response information to a terminal device through communication processing.

### (Supplementary 2)

The system according to supplementary 1,
wherein the processor is configured to, when the user input information relates to an address change, use the personal attribute information and the behavior history information in the analysis to identify conditions of an address change procedure suitable for the user, generate a prompt sentence including the identified conditions, input the prompt sentence into the generative information processing model, and cause the generative information processing model to automatically generate document information required for the address change procedure.

### (Supplementary 3)

The system according to supplementary 1,
wherein the processor is configured to acquire biological information of the user as the user identification information, cooperate with an authentication processing device having a public authentication function to acquire an authentication result of the user, and control access permission to the information storage device and permission to input the prompt sentence into the generative information processing model based on the authentication result.

### Application Example 2

### (Supplementary 1)

A system comprising a processor,
wherein the processor is configured to
provide, via a terminal, an input/output interface for acquiring user input information and to receive, from the terminal, text information, selection information, and identifier information associated with a communication function or an information retrieval function used by the user,
acquire, on the basis of the identifier information and the user input information, history information and attribute information of the user from a storage device or an external information providing apparatus, preprocess the acquired information by using data processing software, analyze a behavioral tendency of the user by using machine learning software, estimate an emotional state of the user by using emotion estimation software, and thereby supplement information required for service provision,
generate, on the basis of the supplemented information and the emotional state, context information including a task type, a required document type, candidate recommendation information, and user interface control information, and construct a prompt sentence in natural language to be input to a generative AI model,
transmit the prompt sentence to the generative AI model via a network, receive generated text from the generative AI model, parse the generated text to extract document data,
recommendation data, or user interface control data, and automatically execute document generation processing or input assistance processing by combining the extracted data with template data,
transmit the document data, the recommendation data, or the user interface control data to the terminal, cause the terminal to present the data to the user, receive modification operations or confirmation operations from the user via the terminal, update the document data or the like on the basis of contents of the operations, and, when necessary, regenerate a prompt sentence for re-input to the generative AI model, and
after final confirmation by the user, transmit the document data or transaction-related data to an external processing apparatus, store a transmission result as history information, and reflect the history information in subsequent information supplementation processing and prompt sentence generation processing.

### (Supplementary 2)

The system according to supplementary 1,
wherein the processor is configured to, when the user input information relates to a change of address information, supplement items required for an address change on the basis of the identifier information and the history information, generate a prompt sentence for causing the generative AI model to create a full text of a notification document or an application document necessary for an address change procedure, automatically embed generated text in an address change document template, and cause the terminal to present the embedded document and execute submission processing.

### (Supplementary 3)

The system according to supplementary 1,
wherein the processor is configured to cooperate with an authentication processing apparatus by using biometric information or authentication information acquired from the terminal, perform user authentication in accordance with an authentication protocol, and control at least one of a content of the prompt sentence to be input to the generative AI model and a finalization process of the document data in accordance with an authentication result so as to improve reliability of authentication.

What is claimed is:

1. A system comprising:
circuitry configured to
receive, via a communication interface coupled to a packet-switched network, input data and identifier information from a terminal device,
extract, based on the identifier information, complementary data comprising attribute information and history information from a storage device,
apply a natural language processing algorithm to the input data and the complementary data to generate structured data,
construct a prompt sentence for a generative neural network model based on the structured data, and input the prompt sentence to the generative neural network model to generate response data,
execute post-processing on the response data comprising format unification, language adjustment, and content filtering to generate output data, and
transmit the output data to the terminal device for display via a graphical user interface.

2. The system according to claim 1, wherein the circuitry is further configured to perform verification and normalization of the input data prior to applying the natural language processing algorithm, the normalization comprising at least one of character encoding conversion, whitespace removal, and data type validation.

3. The system according to claim 2, wherein the natural language processing algorithm extracts from the input data a request type and a plurality of related items by performing tokenization, part-of-speech tagging, and semantic role labeling on the input data.

4. The system according to claim 3, wherein the complementary data further comprises time information and region information acquired based on the identifier information, and the circuitry combines the time information and the region information with the extracted request type and the plurality of related items to generate the structured data.

5. The system according to claim 4, wherein the circuitry is further configured to acquire past dialogue history information associated with the identifier information from the storage device, and to include the past dialogue history information in the prompt sentence as context data for the generative neural network model.

6. The system according to claim 5, wherein the circuitry is further configured to adjust the prompt sentence so that a length of the prompt sentence falls within a predetermined token count range prior to inputting the prompt sentence to the generative neural network model.

7. The system according to claim 1, wherein the post-processing further comprises a safety determination based on predetermined criteria, and the circuitry removes or replaces content in the response data that does not satisfy the predetermined criteria.

8. The system according to claim 7, wherein the circuitry is further configured to integrate the response data with additional information acquired from an external information providing apparatus via the packet-switched network to generate the output data.

9. The system according to claim 1, wherein the circuitry is further configured to combine the structured data with a predefined instruction template to construct the prompt sentence, and to transmit the prompt sentence together with generation parameters to the generative neural network model.

10. The system according to claim 9, wherein the circuitry is further configured to receive evaluation information regarding the output data from the terminal device, store the evaluation information in the storage device, and update at least one of the predefined instruction template and the generation parameters based on the evaluation information.

11. The system according to claim 10, wherein the circuitry is further configured to aggregate the evaluation information by statistical processing, and dynamically adjust at least one of a structure of the prompt sentence and the generation parameters corresponding to a topic extracted from the input data.

12. The system according to claim 1, wherein the identifier information comprises at least one of a communication application identifier associated with a messaging function and an information search tool identifier associated with a search function used by a user of the terminal device.

13. The system according to claim 12, wherein the circuitry is further configured to analyze a behavioral tendency of a user by applying a machine learning model to the attribute information and the history information, and to estimate an emotional state of the user by applying an emotion estimation model to the input data.

14. The system according to claim 13, wherein the circuitry is further configured to generate context information comprising a task type, a required output type, and candidate recommendation information based on the behavioral tendency and the emotional state, and to include the context information in the prompt sentence.

15. The system according to claim 14, wherein the circuitry is further configured to, when the input data relates to a change of residential information for an address change procedure, generate a prompt sentence including body text candidates and input item candidates for a document used in the address change procedure, and automatically generate a description region in an application form template using the response data.

16. The system according to claim 15, wherein the circuitry is further configured to receive biometric authentication information from the terminal device, verify user identity in cooperation with a public authentication apparatus, and control finalization of document data based on a verification result.

17. The system according to claim 16, wherein the circuitry is further configured to, after receiving a confirmation operation from the terminal device, transmit the document data to an external processing apparatus, store a transmission result as history information in the storage device, and reflect the history information in subsequent prompt sentence generation.

18. A system comprising:
circuitry configured to
receive, via a communication interface coupled to a packet-switched network, input data and identifier information from a terminal device,
extract, based on the identifier information, complementary data comprising attribute information, history information, and behavioral tendency data from a storage device,
apply a natural language processing algorithm to the input data and the complementary data to generate structured data, and estimate an emotional state based on the input data using an emotion estimation model,
construct a prompt sentence for a generative neural network model based on the structured data and the emotional state, and input the prompt sentence to the generative neural network model to generate response data,
parse the response data to extract document data and combine the extracted document data with template data to execute document generation processing,
execute post-processing on the response data comprising format unification, safety determination, and content filtering to generate output data,
transmit the output data to the terminal device for display via a graphical user interface, and receive modification operations from the terminal device to update the output data, and
after receiving a confirmation operation, transmit finalized output data to an external processing apparatus and store a result as history information in the storage device.

19. The system according to claim 18, wherein the circuitry is further configured to receive biometric authentication information from the terminal device, verify user identity in cooperation with a public authentication apparatus, and control at least one of a content of the prompt sentence and a finalization process of the output data based on a verification result.

20. A method comprising:
receiving, via a communication interface coupled to a packet-switched network, input data and identifier information from a terminal device,
extracting, based on the identifier information, complementary data comprising attribute information and history information from a storage device,
applying a natural language processing algorithm to the input data and the complementary data to generate structured data,
constructing a prompt sentence for a generative neural network model based on the structured data, and inputting the prompt sentence to the generative neural network model to generate response data,
executing post-processing on the response data comprising format unification, language adjustment, and content filtering to generate output data, and
transmitting the output data to the terminal device for display via a graphical user interface.
